(19) United States
(12) Patent Application Publication
(10) Pub. No.: US 2012/0281641 A1
(43) Pub. Date: Nov. 8, 2012

(54) ORTHOGONAL FREQUENCY DIVISION MULTIPLE ACCESS (OFDMA) SUBBAND AND POWER ALLOCATION

(75) Inventors: YING CUI, HONG KONG (CN); KIN NANG LAU, HONG KONG (CN)

(73) Assignee: THE HONG KONG UNIVERSITY OF SCIENCE AND TECHNOLOGY, HONG KONG (CN)

(21) Appl. No.: 13/223,799

(22) Filed: Sep. 1, 2011

Related U.S. Application Data
(60) Provisional application No. 61/483,509, filed on May 6, 2011.

(51) Int. Cl. H04W 72/04

(52) U.S. Cl. 370/329

(57) ABSTRACT

Distributed queue-aware power and subband allocation for delay-optimal OFDMA uplink systems with one base station, K users, and N_{F} independent subbands are described. For instance, the disclosed subject matter describes distributed delay-optimal power and subband allocation designs and control actions that are a function of instantaneous Channel State Information and joint Queue State Information. The disclosed details enable various refinements and modifications according to system design and tradeoff considerations.

### CROSS-REFERENCE TO RELATED APPLICATIONS

This application claims priority to U.S. Provisional Patent Application No. 61/483,509, entitled DISTRIBUTIVE STOCHASTIC LEARNING FOR DELAY-OPTIMAL OFDMA POWER AND SUBBAND ALLOCATION, and filed on May 6, 2011, the entirety of which is incorporated herein by reference.

### FIELD OF THE INVENTION

The disclosed subject matter relates generally to wireless communications and, more particularly, to orthogonal frequency division multiple access (OFDMA) subband and power allocation.

### BACKGROUND OF THE INVENTION

Orthogonal frequency division multiplexing (OFDM) has developed into a popular scheme for wideband digital communication, whether wireless or over copper wires, and can be used in applications such as digital television and audio broadcasting, wireless networking and broadband internet access, as well as other digital communications applications. For multiuser communications, OFDM can be employed by dividing the total bandwidth into traffic channels or a subset of OFDM subcarriers so that multiple access can be accommodated in an orthogonal frequency division multiple access (OFDMA) schemes.

Conventional cross-layer optimization of power and subband allocation in OFDMA systems typically focus on optimizing physical layer performance, and thus, power and subband allocation solutions derived are functions of the channel state information (CSI) only. On the other hand, real life applications are delay-sensitive and it is critical to consider the bursty arrivals and delay performance in addition to the conventional physical layer performance (such as sum-rate or proportional fair) in OFDMA cross-layer design.

However, a combined framework that takes into account both queuing delay and physical layer performance is not trivial as it can be understood to involve both queuing theory (e.g., to model queue dynamics) and information theory (e.g., to model physical layer dynamics). For example, one such combined approach converts a delay constraint into an average rate constraint using tail probability at large delay regime and solves the optimization problem using information theoretical formulation based on the rate constraint. While this can allow a potentially simple solution, the derived control policy will be a function of the CSI only, which can be expected to have limited applicability to large delay regimes where the probability of buffer empty is small.

Accordingly, delay-optimal control actions should generally be a function of both the CSI and queue state information (QSI). In other approaches, a Longest Queue Highest Possible Rate (LQHPR) policy can be shown to be delay-optimal for multi-access fading channels, in limited theoretical contexts. For example, such solutions utilizing stochastic majorization theory can require symmetry among the users, which can be difficult or impractical to extend to other situations. In yet other approaches that focus on the queue stability region of various wireless systems using Lyapunov drift, the solutions can be limited to systems involving large delay.

While conventional solutions address different aspects of the delay sensitive resource allocation problem, there are still a number of first order issues to be addressed to obtain decentralized resource optimization for delay-optimal uplink OFDMA systems. For instance, while a more general approach can be to model the problem as a Markov Decision Problem (MDP), a primary difficulty in determining the optimal policy using the MDP approach is the huge state space involved. For instance, the state space is exponentially large in the number of users. As an example, for a system with 4 users, 6 independent subbands, a buffer size of 50 per user and 4 channel states, the system state space can contain an unmanageable number of 4^{4×6}×(50+1)⁴ states (e.g., due to the exponential growth of state space, etc).

In addition, conventional solutions are typically centralized in which processing is done at the base station (BS) requiring global knowledge of CSI and QSI from K users. However, in the uplink direction, the QSI is typically only available locally at each of the K users. Hence, centralized solution at the BS could require all the K users to deliver their QSI to the BS, which can consume enormous signaling overhead, and could require the BS to broadcast the allocation results for the resource allocations at the mobile side in the uplink system. In addition, such centralized solutions could lead to an exponential computational complexity of the BS.

Moreover, while a number of conventional solutions for decentralized OFDMA control use deterministic game or primal-dual decomposition theory for solving deterministic network utility maximization, such derived distributed algorithms are iterative in nature where all nodes are expected to exchange some messages explicitly in solving the master problem. However, in such conventional solutions, CSI is typically assumed to be quasi-static during the iterative updates with message passing. When considering delay-optimization, the problem may not be static or quasi-static but can be expected to be stochastic in nature. As a result, delay-optimization is quite challenging, because the game, as it were, is played repeatedly and the actions as well as the payoffs are defined over ergodic realizations of the system states (e.g., CSI, QSI). Thus, during iterative updates, the system state will be expected to be not quasi-static, and as a result, convergence of a stochastic iterative solution is not assured.

The above-described deficiencies are merely intended to provide an overview of some of the problems encountered in providing distributed delay-optimal power and subband allocation design for uplink OFDMA systems, and are not intended to be exhaustive. Other problems with conventional systems and corresponding benefits of the various non-limiting embodiments described herein may become further apparent upon review of the following description.

### SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the disclosed subject matter in a simplified form as a prelude to the more detailed description that follows.

In consideration of the above-described deficiencies of the state of the art, the disclosed subject matter provides apparatuses, related systems, and methods associated with subband and power allocation.

According to non-limiting aspects, a network entity, such as a base station (BS), a resource allocation controller, or the like, can determine a subband allocation policy, and so on, based in part on both channel state information (CSI) and queue state information (QSI) as further described herein.

Thus, in various non-limiting implementations, the disclosed subject matter provides systems for wireless communication resource allocation configured to perform a per-stage subband auction, to facilitate subband and power allocation based in part on joint channel state information and joint queue state information. In other non-limiting implementations, methods are provided that facilitate resource allocation (e.g., subband and power allocation) in a wireless communication system by generating a resource allocation policy based on bids for resource allocation and a per-stage subband auction mechanism as further described herein. Further exemplary implementations are directed to a resource allocation controller configured to perform various non-limiting aspects of the disclosed subject matter. Additionally, various modifications are provided, which achieve a wide range of performance and computational overhead trade-offs according to system design considerations.

In various non-limiting implementations a distributed delay-optimal power and subband allocation design for uplink OFDMA system, which can be cast into an infinite-horizon average-cost CMDP is described herein. To address the distributed requirement and the issue of exponential memory requirement and computational complexity, various non-limiting implementations can employ a per-user online learning with per-stage auction, which can employ local QSI and local CSI. It is demonstrated that under the per-stage auction as described herein, the distributed online learning solution converges with probability 1. As a non-limiting illustration, non-limiting implementations of the described learning algorithm can be applied to an application example with exponential packet size distribution. According to various non-limiting aspects, delay-optimal power control as described herein can have the multi-level water-filling structure, and non-limiting implementations of the described learning algorithm can converge to the global optimal solution for sufficiently large number of users. Numerical simulation results described herein demonstrate significant delay performance gain over various comparative baselines.

These and other embodiments are described in more detail below.

### BRIEF DESCRIPTION OF THE DRAWINGS

The disclosed techniques and related systems and methods are further described with reference to the accompanying drawings in which:

FIG. 1 depicts an uplink OFDMA system suitable for incorporation of aspects the disclosed subject matter;

FIG. 2 depicts an uplink OFDMA system exemplifying non-limiting physical layer and queuing models environment suitable for incorporation of aspects the disclosed subject matter;

FIG. 3 depicts a flowchart of exemplary methods for power and subband allocation, according to particular aspects of the subject disclosure;

FIGS. 4-5 depict non-limiting flowchart of an exemplary algorithm for online distributed primal-dual value iteration algorithm with per-stage auction and simultaneous updates on potential and Lagrange multipliers, according to various non-limiting implementations of the disclosed subject matter;

FIG. 6 depicts a non-limiting block diagram of systems for wireless communication resource allocation, according to various non-limiting aspects of the disclosed subject matter;

FIG. 7 illustrates an exemplary non-limiting resource allocation controller suitable for performing various techniques of the disclosed subject matter;

FIG. 8 illustrates exemplary non-limiting systems or apparatuses suitable for performing various techniques of the disclosed subject matter;

FIGS. 9-13 demonstrate exemplary performance of various non-limiting embodiments, in accordance with aspects of the disclosed subject matter;

FIG. 14 is a block diagram representing an exemplary non-limiting networked environment in which the disclosed subject matter may be implemented;

FIG. 15 is a block diagram representing an exemplary non-limiting computing system or operating environment in which the disclosed subject matter may be implemented; and

FIG. 16 illustrates an overview of a network environment suitable for service by embodiments of the disclosed subject matter.

### DETAILED DESCRIPTION OF ILLUSTRATIVE EMBODIMENTS

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow.

It is understood that various modifications may be made by one skilled in the relevant art without departing from the scope of the disclosed subject matter. Accordingly, it is the intent to include within the scope of the disclosed subject matter those modifications, substitutions, and variations as may come to those skilled in the art based on the teachings herein.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Also the terms “user,” “mobile user,” “mobile device,” “mobile station,” and so on are used interchangeably to describe technological functionality (e.g., device, components, or subcomponents thereof, combinations, and so on etc.) configured to at least receive and transmit electronic signals and information according to various aspects of the disclosed subject matter.

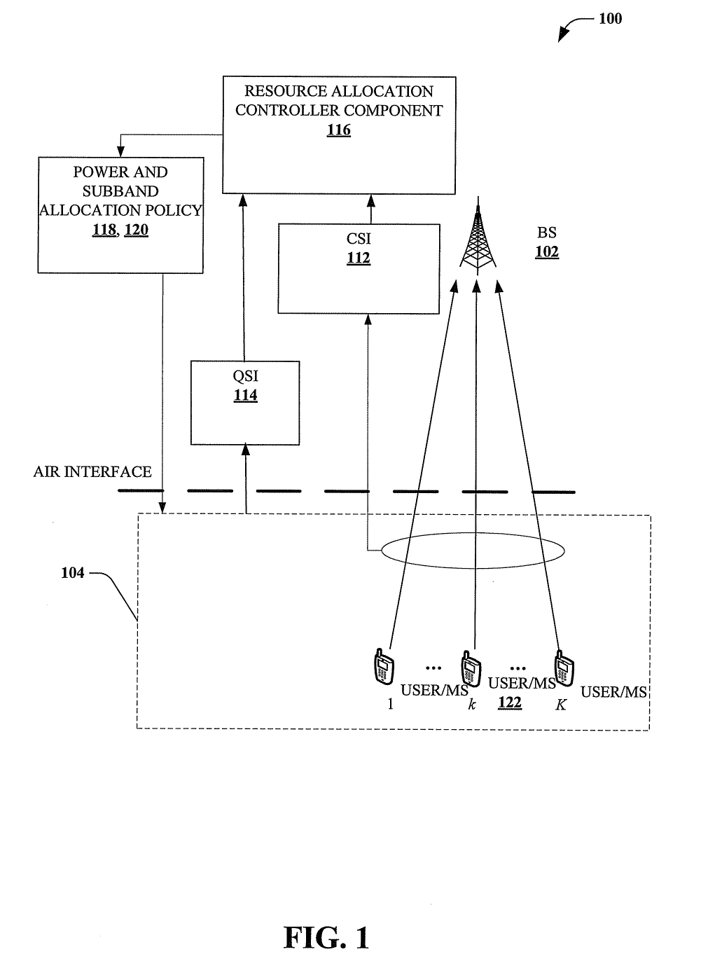

In various non-limiting implementations, the disclosed subject matter provides distributed queue-aware power and subband allocation designs for delay-optimal OFDMA uplink systems. For example, the disclosed subject matter is described in the context of an OFDMA uplink system with one base station (BS), K users, and N_{F} independent subbands, as further described below regarding FIG. 1. According to various non-limiting examples, the delay-optimal problem can be cast into an infinite horizon average cost constrained Markov Decision Process. To address the distributed requirement and the issue of exponential memory requirement and computational complexity, a distributed online stochastic learning algorithm is described herein, which can employ knowledge of the local QSI and the local CSI at each of the K mobiles and can be utilized to determine the resource control actions using a per-stage auction. For example, using separation of time scales, it can be shown that under the disclosed auction mechanism, the distributed online stochastic learning converges almost surely.

As a non-limiting illustration, a distributed stochastic learning framework is described herein for an application example with exponential packet size distribution. Thus, in various non-limiting implementations, delay-optimal power control can exhibit a multi-level water-filling structure where CSI can determine instantaneous power allocation and QSI can determine the water level. In addition, for sufficiently large number of users, it can be shown that the disclosed algorithms converge to a global optimal solution and can have linear signaling overhead and computational complexity [symbol] (KN), which is desirable from an implementation perspective.

### System Model

FIG. 1 depicts an uplink OFDMA system 100 suitable for incorporation of aspects the disclosed subject matter. As illustrative examples, distributed queue-aware power and subband allocation designs for delay-optimal OFDMA uplink systems are described having one base station 102, K users 104 (e.g., users, mobile users, mobile devices, mobile stations, etc.) and N_{F} independent subbands 106 (not shown). As used herein, the following notations are employed to described various non-limiting aspects of the disclosed subject matter: K can denote number of users 104; N_{F} can denote number of independent subbands 106; N_{Q} can denote buffer size; k, n can denote user, subband index; N̅ₖ can denote mean packet size of user k; t can denote slot index; s_{k,n}, p_{k,n} can denote subband, power allocation action; Ω=(Ωₚ,Ωₛ) can denote power and subband allocation policy; H={|H_{k,n}|} can denote joint CSI; Q=(Qₖ) can denote joint QSI; A=(Aₖ) can denote bit/packet arrival vector; χ=(H,Q) global system state; τ can denote frame duration; λₖ can denote average arrival rate of user k; μ̅_{K}(Q) can denote conditional mean departure rate of user k (conditioned on Q); Pₖ, Pₖ^{d} can denote total power and packet drop rate constraints of user k; {V(χ)} can denote system potential function on z; { [symbol] (χ,s)} can denote subband allocation Q-factor; { [symbol] ^{k}(χₖ,sₖ)} can denote per-user subband allocation Q-factor; {q^{k}(Q,H,s)} can denote the per-user per-subband subband allocation Q-factor; γ̅^{k} can denote Lagrange multiplier (LM) with respect to the average power constraint of k; γ^{k} LM with respect to average packet drop constraint of k; {εₜ^{q}} can denote the step size sequence for the per-user potential update; and {εₜ^{γ}} can denote step size sequence for per-user 2 LMs update.

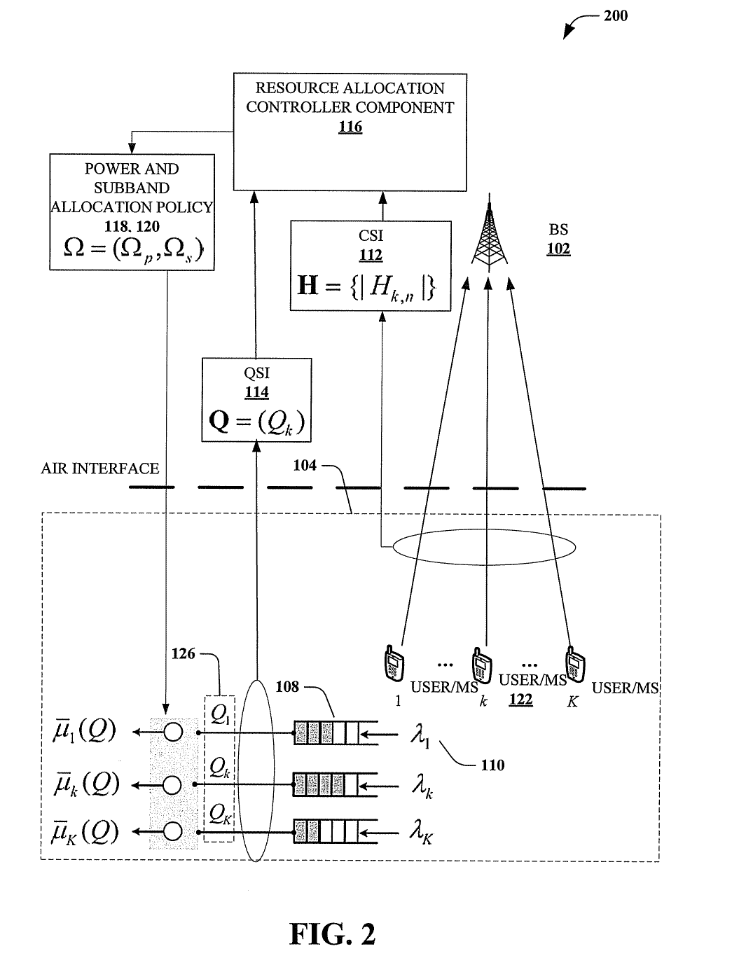

FIG. 2 depicts an uplink OFDMA system 200 exemplifying non-limiting physical layer and queuing models environment suitable for incorporation of aspects the disclosed subject matter. As described above, in various non-limiting examples, distributed queue-aware power and subband allocation designs for delay-optimal OFDMA uplink systems can have one base station 102, K users 104, and N_{F} independent subbands 106 (not shown). Each mobile can have an uplink queue 108 with heterogeneous packet arrivals 110 and delay requirements. In various non-limiting embodiments, the problem can be defined as an infinite horizon average cost MDP where the control policies are functions of the instantaneous CSI 112 as well as the joint QSI 114.

To address the distributed requirement and the issue of exponential memory requirement and computational complexity, a distributed online stochastic learning algorithm is described herein, which can employ knowledge of the local QSI and the local CSI at each of the K mobiles and can be utilized to determine the resource control actions using a per-stage auction. For example, in various non-limiting implementations, subband allocation Q-factor can be approximated by the sum of the per-user subband allocation Q-factor and a distributed online stochastic learning algorithm can be employed to estimate the per-user Q-factor and the LMs simultaneously and determine the control actions using an auction mechanism. Under the disclosed auction mechanism, the distributed online learning converges almost surely (with probability 1), as further described herein.

As mentioned, in an exemplary system model 100 including an OFDMA physical layer model as well as an underlying queuing model, there can be one BS 102 and K mobile users 106 (e.g., each with one uplink queue 108) in the OFDMA uplink system 100 with L subcarriers over a frequency selective fading channel with N_{F} independent multipaths or subbands 104 as illustrated in FIG. 1. The BS 102 can employ a cross-layer controller 116 (e.g., a resource allocation controller, a resource allocation controller component (RACC), etc), which can utilize joint CSI 112 and joint QSI 114 as inputs and can produce power allocation 118 and subband allocation 120 actions as outputs. It is noted that, while for ease of illustrations, the problem is first formulated in a centralized manner, and then the distributed solution is addressed.

Accordingly, describing an exemplary OFDMA physical layer model, s_{k,n}ε{0,1} can denote the subband allocation for the k-th user 122 at the n-th subband 124, and the received signal from the k-th user 122 at the n-th subband 124 of the base station 102 can be given by Y_{k,n}^{r}=S_{k,n}(H_{k,n}tX_{k,n}t+Z_{k,n}), where X_{k,n}^{t} can denote the transmitted symbol, H_{k,n} and Z_{k,n}(˜ [symbol] (0,1)) are random fading and channel noise of the k-th user 122 at the n-th subband 124, respectively. The data rate of user k 122 can be expressed as:

$${R}_{k} = {\sum }_{n = 1}^{{N}_{F}} {R}_{k , n} = {\sum }_{n = 1}^{{N}_{F}} {S}_{k , n} log ( 1 + ξ {p}_{k , n} {\vert {H}_{k , n} \vert}^{2} ) \qquad ( 1 )$$

for some constant ξ. Note that the data rate expression in Eqn. 1 can be used to model both the uncoded and coded systems. For uncoded system using Multi-Level Quadrature Amplitude Modulation (MQAM) constellation, the bit error rate (BER) of the n-th subband 124 and the k-th user 122 can be given by

$$B E {R}_{k , n} \approx {c}_{1} exp ( - {c}_{2} \frac{{Γ}_{k , n}}{{2}^{{R}_{k , n}} - 1} ) ,$$

where Γ_{k,n} can denote received signal-to-noise ratio (SNR) of the k-th user 122 at the n-th subband 124, and hence, for a target BER ε,

$$ξ = - \frac{{c}_{2}}{ln ( ε / {c}_{1} )} .$$

On the other hand, for system with powerful error correction codes such as low-density parity-check (LDPC) with reasonably large block length (e.g., 8 Kilobyte (Kbyte)) and target packet error rate (PER) of 0.1 percent (%), the maximum achievable data rate can be given by instantaneous mutual information (to within 0.5 decibel (dB) SNR). In that case, ξ=1. It is noted that for notation simplicity, derived results as described herein are based on ξ=1, which results can be easily extended to other cases.

The following describes exemplary source model, queue dynamics and control policy suitable for illustration of various non-limiting aspects of the disclosed subject matter. For instance, in various examples, the time dimension can be partitioned into scheduling slots indexed by t with slot duration τ.

Assumption 1: Joint CSI 112 of an exemplary system 100 can be denoted by H(t)={|H_{k,n}(t)|∀k,n}, where |H_{k,n}(t)| can denote a discrete random variable (r.v.) distributed according to Pr[|H|]. The CSI 112 can be assumed quasi-static within a scheduling slot and independently and identically distributed (i.i.d.) between scheduling slots. It is noted that while the quasi-static assumption can be a realistic assumption for pedestrian mobility users where the channel coherence time is around 50 milliseconds (ms), typical frame duration is less than 5 ms in next generation wireless systems such as WiMAX™. On the other hand, it can be assumed the CSI is i.i.d. between slots in order to capture first order insights. Similar solution frameworks can also be extended to deal with correlated fading.

In a further non-limiting aspect, A(t)=(A₁(t), . . . , A_{K}(t)) can denote the random new arrivals (number of bits) at the end of the t-th scheduling slot.

Assumption 2: The arrival process Aₖ(t) can be assumed i.i.d. over scheduling slots according to a general distribution Pr(Aₖ) with average arrival rate [symbol] [Aₖ]=/λₖ.

Let Q(t)=(Q₁(t), . . . , Q_{K}(t)) denote the joint QSI 114 of the K-user OFDMA system 100, where Q, (t) 126 can denote the number of bits in the k-th queue at the beginning of the t-th slot. N_{Q} can denote the maximum buffer size (number of bits). Thus, the cardinality of the joint QSI 114 can be I_{Q}=(N_{Q}+1)^{K}, which can be expected to grow exponentially with K. Let N_{H} denote the cardinality of |H_{k,n}|(∀k,n). Hence, the cardinality of the global CSI can be given by I_{H}=N_{H}^{N}^{_{F}}^{K}. Let R(t)=(R₁(t), . . . , R_{K}(t)) (bits/second) be the scheduled data rates of the K users, where Rₖ(t) is given by Eqn. 1. It can be assumed that the controller (e.g., cross-layer controller or resource allocation controller 116) is causal so that new bit arrivals A(t) are observed after the controller's actions at the t-th slot. Hence, exemplary queue dynamics can be given by the following equation:

Qₖ(t+1)=min{[Qₖ(t)−Rₖ(t)τ]⁺+Aₖ(t),N_{Q}}, ∀kε{1,K} (2)

where x⁺ [symbol] max {x,0} and τ can denote the duration of a scheduling slot.

For notation convenience, χ(t)=(H(t),Q(t)) can denote the global system state at the t-th slot. Therefore, the cardinality of the state space of χ is I_{χ}=I_{H}×I_{Q}=(N_{H}^{N}^{_{F}}(N_{Q}+1))^{K}. According to various non-limiting implementations, given the observed system state realization χ(t) at the beginning of the t-th slot, the transmitter 128 can adjust transmit power and subband allocation (equivalently data rate R(t)) according to a stationary power control and subband allocation policy defined below. For example, in a non-limiting aspect, at the beginning of the t-th scheduling slot, the controller (e.g., cross-layer controller, resource allocation controller, resource allocation controller component 116) can observe the joint CSI H(t) 112 and the joint QSI Q(t) 114 and can determine the transmit power and subband allocation across the K users 104.

Definition 1: Stationary Power Control and Subband Allocation Policy: A stationary transmit power and subband allocation policy Ω=(Ωₚ,Ωₛ) can be a mapping from the system state χ to the power and subband allocation actions. According to a non-limiting aspect, a policy Ω can be called feasible if the associated actions satisfy an average total transmit power constraint and a subband assignment constraint. Specifically, a policy Ω can be called feasible if Ωₚ(χ)=p={p_{k,n}≧0:∀k,n} 118 and Ωₛ(χ)=s={s_{k,n}ε{0,1}:∀k,n} 120 satisfy

$$\begin{matrix}{\sum }_{n = 1}^{{N}_{F}} [ {p}_{k , n} ] \leq {P}_{k} , ∀ k ∈ \{ 1 , K \} , & ( 3 ) \\ {\sum }_{k = 1}^{K} {s}_{k , n} = 1 , ∀ n ∈ \{ 1 , {N}_{F} \} & ( 4 )\end{matrix}$$

In further non-limiting implementations, Ω can also satisfy an average packet drop rate constraint for each queue as follows:

Pr[Qₖ=N_{Q}]≦Pₖ^{d},∀kε{1,K} (5)

From Eqn. 1, the vector queue dynamics can be seen to be Markovian with the transition probability given by

$$\begin{matrix}Pr [ Q ( t + 1 ) \vert χ ( t ) , Ω ( χ ( t ) ) ] = Pr [ A ( t ) Q ( t + 1 ) - {[ Q ( t ) - R ( t ) τ ]}^{+} ] \\ = {\prod }_{k} Pr [ {A}_{k} ( t ) = {Q}_{k} ( t + 1 ) - \\ {[ {Q}_{k} ( t ) - {R}_{k} ( t ) τ ]}^{+} ]\end{matrix} \qquad ( 6 )$$

Note that the K queues 108 can be coupled via the control policy Ω and the constraint in Eqn. 4.

From Assumption 1, the induced random process χ(t)=(H(t),Q(t)) can be expected to be Markovian with the following transition probability:

$$\begin{matrix}Pr [ χ ( t + 1 ) \vert χ ( t ) , Ω ( χ ( t ) ) ] = Pr [ H ( t + 1 ) \vert χ ( t ) , Ω ( χ ( t ) ) ] \\ Pr [ Q ( t + 1 ) \vert χ ( t ) , Ω ( χ ( t ) ) ] \\ = Pr [ H ( t + 1 ) ] \\ Pr [ Q ( t + 1 ) \vert χ ( t ) , Ω ( χ ( t ) ) ]\end{matrix} \qquad ( 7 )$$

where Pr[Q(t+1)|χ(t),Ω(χ(t))] can be given by Eqn. 6. Given a unichain policy Ω, the induced Markov chain {χ(t)} can be ergodic and there can exist a unique steady state distribution π_{χ} where

$${π}_{χ} ( χ ) = {lim}_{t \to ∞} Pr [ χ ( t ) = χ ] .$$

it is noted that, although the QSI Q(t+1) 112 and CSI H(t) 114 can be correlated via the control action Ω(χ(t)), due to the i.i.d. assumption of CSI in Assumption 1, H(t+1) can be expected to be independent of χ(t). Note further that H(t) being i.i.d. is a special case of Markovian model. Thus, Eqn. 7 can be expected to hold under the H(t) i.i.d. assumption in Assumption 1. Accordingly, the average utility of the k-th user under a unichain policy Ω can be given by:

$${\overline{T}}_{k} ( Ω ) = {lim}_{T \to ∞} \frac{1}{T} {\sum }_{t = 1}^{T} [ f ( {Q}_{k} ( t ) ) ] = {{π}_{χ}}_{} [ f ( {Q}_{k} ) ] , ∀ k ∈ \{ 1 , K \} \qquad ( 8 )$$

where f(Qₖ) denotes a monotonic increasing function of Qₖ and [symbol] _{π}_{_{χ}} denotes expectation with respect to the underlying measure π_{χ}. For example, when

$$f ( {Q}_{k} ) = \frac{{Q}_{k}}{{λ}_{k}} , {\overline{T}}_{k} ( Ω ) = \frac{1}{{λ}_{k} } {{π}_{χ}}_{} [ {Q}_{k} ]$$

can denote the average delay of the k-th user 122. Another interesting example, the queue outage probability, T̅ₖ(Ω)=Pr[Qₖ≧Qₖ^{o}] in which f(Qₖ)=1[Qₖ≧Qₖ^{o}], where Qₖ^{o}ε{0,N_{Q}} is the reference outage queue state.

Similarly, the average transmit power constraint in Eqn. 3 and the packet drop constraint in Eqn. 5 can be written as

$$\begin{matrix}\begin{matrix}{\overline{P}}_{k} ( Ω ) = {lim}_{T \to ∞} \frac{1}{T} {\sum }_{t = 1}^{T} [ {\sum }_{n} {p}_{k , n} ( t ) ] \\ = {{π}_{χ}}_{} [ {\sum }_{n} {p}_{k , n} ] \leq {P}_{k} , ∀ k ∈ \{ 1 , K \}\end{matrix} & ( 9 ) \\ \begin{matrix}\overline{{P}_{k}^{d}} ( Ω ) = {lim}_{T \to ∞} \frac{1}{T} {\sum }_{t = 1}^{T} [ 1 [ {Q}_{k} ( t ) = {N}_{Q} ] ] \\ = {{π}_{χ}}_{} [ 1 [ {Q}_{k} = {N}_{Q} ] ] \leq {P}_{k}^{d} , ∀ k ∈ \{ 1 , K \}\end{matrix} & ( 10 )\end{matrix}$$

### CMDP Formulation and General Solution of the Delay-Optimal Problem

According to various non-limiting implementations, the delay-optimal problem can be formulated as an infinite horizon average cost constrained Markov Decision Problem (CMDP). As a non-limiting example, an MDP can be characterized by a tuple of four objects (e.g., the state space, the action space, the transition probability kernel, and the per-stage cost function). In the delay-optimization problem, these four objects can be associated as follows:

State Space: The state space for the MDP can be given by {χ¹, . . . , χ^{I}^{_{χ}}}, where, χⁱ=(Hⁱ,Qⁱ)(1≦i≦I_{χ}) denotes a realization of the global system state.

Action Space: The action space of the MDP can be given by {Ω(χ¹), . . . , Ω(χ^{I}^{_{χ}})}, where Ω denotes a unichain feasible policy as defined in Definition 1.

Transition Kernel: The transition kernel of the MDP Pr[χ^{j}|χⁱ,Ω(χⁱ)] can be given by Eqn. 7.

Per-stage Reward: The per-stage cost function of the MDP can be given by

$$d ( χ , Ω ( χ ) ) = {\sum }_{k} {β}_{k} f ( {Q}_{k} ) .$$

As a result, in various non-limiting implementations, the delay-optimal control problem can be formulated as a CMDP, which is summarized below.

Problem 1: Delay-Optimal Constrained MDP: For some positive constants β=(β₁, . . . , β_{K}), the delay-optimal problem is formulated as

$$\begin{matrix}{min}_{Ω} {J}_{β} ( Ω ) = {\sum }_{k = 1}^{K} {β}_{k} {\overline{T}}_{k} ( Ω ) \\ = {lim}_{T \to ∞} \frac{1}{T} {\sum }_{t = 1}^{T} [ d ( χ ( t ) , Ω ( χ ( t ) ) ) ]\end{matrix} \qquad ( 11 )$$

subject to the power and packet drop rate constraints in Eqns. 9 and 10. It is noted that the positive weighting factors β in Eqn. 11 can indicate the relative importance of buffer delay among the K data streams and for each given β, the solution to Eqn. 11 can corresponds to a point on the Pareto optimal delay tradeoff boundary of a multi-objective optimization problem.

In a Lagrangian approach to the CMDP, for any LMs γ̅^{k},γ^{k}>0, the Lagrangian can be defined as

$${L}_{β} ( Ω , γ ) = {lim}_{T -> ∞} \frac{1}{T} {\sum }_{t = 1}^{T} 𝔼 [ g ( γ , χ , Ω ( χ ) ) ] ,$$

where γ=(γ¹, . . . , γ^{K}) with γ^{k}= γ̅^{k},γ^{k})
and

$$g ( γ , χ , Ω ( χ ) ) = {\sum }_{k} ( {β}_{k} f ( {Q}_{k} ) + {\overline{γ}}^{k} ( {\sum }_{n} {p}_{k , n} - {P}_{k} ) + {\underline{γ}}^{k} ( 1 [ {Q}_{k} = {N}_{Q} ] - {P}_{k}^{d} ) ) .$$

Thus, the corresponding unconstrained MDP for a particular LM γ can be given by

G(γ)=min_{Ω}L_{β}(Ω,γ) (12)

where G(γ) gives the Lagrange dual function. The dual problem of the primal problem in Problem 1 can be given by [symbol] G(γ). The general solution to the unconstrained MDP in Eqn. 12 is summarized in the following lemma

Lemma 1, Bellman equation and subband allocation Q-factor, for a given γ, the optimizing policy for the unconstrained MDP in Eqn. 11 can be obtained by solving Bellman equation (associated with the MDP in Eqn. 11 with respect to (θ,{ [symbol] (χ,s)}) as below:

$$\begin{matrix} ( {χ}^{i} , s ) = {min}_{{Ω}_{p} ( {χ}^{i} )} [ g ( γ , {χ}^{i} , s , {Ω}_{p} ( {χ}^{i} ) ) + {\sum }_{{χ}^{i}} Pr [ {χ}^{j} \vert {χ}^{i} , s , {Ω}_{p} ( {χ}^{i} ) ] {min}_{{s}^{′}} ( {χ}^{j} , {s}^{′} ) ] - θ & ( 13 ) \\ ∀ 1 \leq i \leq {I}_{χ} , ∀ s & \end{matrix}$$

where θ=L*_{β}(γ)=min_{Ω}L_{β}(Ω,γ) denotes the optimal average cost per stage and { [symbol] (χ,s)} denotes the subband allocation Q-factor. The optimal control policy can be given by Ω*=(Ωₚ*,Ωₛ*) with Ωₚ*(χⁱ) attaining the minimum of the right hand side (R.H.S.) of Eqn. 13 and Ωₛ*(χⁱ)=arg minₛ [symbol] (χⁱ,s) for any χⁱ. Because the policy space considered consists of only unichain policies, the associated Markov chain {χ(t)} can be expected to be irreducible and there exists a recurrent state. It is noted that for sufficiently large total transmit power {P₁, . . . , P_{K}} so that the optimization problem in Eqn. 11 is feasible, and the state χ=(H,Q) (∀H and Q=(0, . . . , 0)) is recurrent. Thus, the solution to Eqn. 14 can be seen to be unique up to an additive constant.

As proof of Lemma 1, for a given γ, the optimizing policy for the unconstrained MDP in Eqn. 12 can be obtained by solving the Bellman Equation in Eqn. 13 with respect to (θ,{V(χ)}) as below:

$$\begin{matrix}θ + V ( {χ}^{i} ) , ∀ 1 \leq i \leq {I}_{χ} = & ( 14 ) \\ {min}_{Ω ( {χ}^{i} )} [ g ( γ , {χ}^{i} , Ω ( {χ}^{i} ) ) + {\sum }_{{χ}^{i}} Pr [ {χ}^{j} \vert {χ}^{i} , Ω ( {χ}^{i} ) ] V ( {χ}^{j} ) ] & \end{matrix}$$

where χ(χⁱ)=(p,s) can denote the power control and subband allocation actions taken in state χⁱ,

$$θ = {L}_{β}^{*} ( γ ) = {inf}_{Ω} {L}_{β} ( Ω , γ )$$

can denote the optimal average cost per stage, {V(χ)} can denote the potential function of the MDP.
Because Ω(χⁱ)=(χₛ(χⁱ),Ωₚ(χⁱ)), the subband allocation Q-factor of state χⁱ under subband allocation action s can be defined
as

$$( {χ}^{i} , s ) {=}^{Δ} {min}_{{Ω}_{p} ( {χ}^{i} )} [ g ( γ , {χ}^{i} , s , {Ω}_{p} ( {χ}^{i} ) ) + {\sum }_{{χ}^{i}} Pr [ {χ}^{j} \vert {χ}^{i} , s , {Ω}_{p} ( {χ}^{i} ) ] V ( {χ}^{j} ) ] - θ .$$

Thus, V(χ)=minₛ [symbol] (χ,s) (∀χ) and { [symbol] (χ,s)} are shown satisfy the Bellman equation in Eqn. 13.

Using standard optimization theory, the problem in Eqn. 12 has an optimal solution for a particular choice of the LM γ=γ*, where γ* can be chosen to satisfy the average power constraint in Eqn. 9 and the packet drop constraint in Eqn. 10. Moreover, it can be shown that the following saddle point condition holds:

L(Ω*,γ)≦L(Ω*,γ*)≦L(Ω,γ) (15)

In other words, (Ω*,γ*) can be expected to be a saddle point of the Lagrangian, then Ω* can be the primal optimal (e.g., solving Problem 1), γ* is the dual optimal (solving the dual problem), and the duality gap can be expected to be zero. Accordingly, in various non-limiting implementations, by solving the dual problem, the primal optimal Ω* can be obtained. It is noted that the optimal control actions can be functions of the subband allocation Q-factor { [symbol] (χ,s)} and the LMs, according to a non-limiting aspect. Unfortunately, for any given LMs, determining the subband allocation Q-factor involves solving the Bellman equation in Eqn. 13, which is a fixed-point problem over the functional space with exponential complexity. In other words, it is a system of K^{N}^{_{F}}I_{χ}=K^{N}^{_{F}}(N_{H}^{N}^{_{F}}(N_{Q}+1))^{K} non-linear equations with K^{N}^{_{F}}I_{χ}+1 unknowns (θ,{ [symbol] (χ,s)}). Furthermore, even if it could be solved, the solution would be centralized and the joint CSI 112 and QSI 114 knowledge would be required, which, as previously described, is undesirable.

### General Decentralized Solution Via Localized Stochastic Learning and Auction

To arrive at a general decentralized solution via localized stochastic learning and auction, according to various non-limiting aspects, key steps in obtaining the optimal control policies from the R.H.S. of the Bellman equation in Eqn. 13 rely on the knowledge of the subband allocation Q-factor { [symbol] (χ,s)} and the LMs { γ̅^{k},γ^{k}} (1≦k≦K), which is very challenging. For instance, brute-force solution of, { [symbol] (χ,s)} and two K LMs has exponential complexity and requires centralized implementation and knowledge of the joint CSI 112 and QSI 114 (which also requires huge signaling overheads). Thus, an approximation of the subband allocation Q-factor Q(χ,s) by the sum of per-user subband allocation Q-factor [symbol] ^{k}(χₖ,sₖ), e.g.,

$$( χ , s ) \approx {\sum }_{k} {k}^{} ( {χ}_{k} , {s}_{k} ) ,$$

is described herein according to further non-limiting aspects. Based on the approximate Q-factor, various embodiments of the disclosed subject matter can employ a per-stage decentralized control policy using a per-stage auction. In addition, further embodiments of the disclosed subject matter can employ a localized online stochastic learning algorithm (performed locally at each MS k 122) to determine the per-user Q-factor { [symbol] ^{k}(χₖ,sₖ)} 126 as well as the two local LMs γ^{k}=( γ̅^{k},γ^{k}) based on observations of the local CSI and QSI as well as the auction result. Furthermore, we shall prove that under the proposed per-stage auction, the local online stochastic learning algorithm converges almost surely (with probability 1).

For the linear approximation on the subband allocation Q-Factor and distributed power control, according to various aspects, the per-user system state, channel state, subband allocation actions, and power control actions can be denoted as χₖ=(Qₖ,Hₖ), Hₖ={|H_{k,n}|:∀n}, sₖ={s_{k,n}:∀n} and pₖ={p_{k,n}:∀n}, respectively. To reduce the size of the state space and to decentralize the resource allocation, [symbol] (χ,s) can be approximated, as described above, by the sum of per-user subband allocation Q-factor [symbol] ^{k}(χₖ,sₖ), e.g.,

$$( χ , s ) \approx {\sum }_{k} {k}^{} ( {χ}_{k} , {s}_{k} ) \qquad 16$$

where [symbol] ^{k}(χₖ,sₖ) satisfies the following per-user subband allocation Q-factor fixed-point equation for each MS k:

$${k}^{} ( {χ}_{k}^{i} , {s}_{k} ) = {min}_{{p}_{k}} [ {g}_{k} ( {γ}^{k} , {χ}_{k}^{i} , {s}_{k} , {p}_{k} ) + {\sum }_{{χ}_{k}^{j}} P r [ {χ}_{k}^{j} \vert {χ}_{k}^{i} , {s}_{k} , {p}_{k} ] {W}^{k} ( {χ}_{k}^{j} ) ] - {θ}^{k} , ∀ 1 \leq i \leq {I}_{χ}^{k} , ∀ {s}_{k} \qquad ( 17 )$$

where

$${g}_{k} ( {γ}^{k} , {χ}_{k} , {s}_{k} , {p}_{k} ) = {β}_{k} f ( {Q}_{k} ) + {\overline{γ}}^{k} ( {\sum }_{n} {p}_{k , n} - {P}_{k} ) + {\underline{γ}}^{k} ( 1 [ {Q}_{k} = {N}_{Q} ] - {P}_{k}^{d} )$$

and W^{k}(χₖ)= [symbol] [symbol] ^{k}(χₖ,{s_{k,n}=1[|H_{k,n}|≧H_{K-1}*]})|χₖ] (H_{K-1}* denotes the largest order statistic of the (K−1) i.i.d. random variables with the same distribution as |H_{k,n}|), and I_{χ}^{k}=N_{H}^{N}^{_{F}}(N_{Q}+1) represents the cardinality of the space of per-user system state. Note that under the subband allocation Q-factor approximation, the state space of K users is significantly reduced from I_{χ}=(N_{H}^{N}^{_{F}}(N_{Q}+1))^{K} to KI_{χ}^{k}=KN_{H}^{N}^{_{F}}(N_{Q}+1).

According to further non-limiting aspects, for a per-stage subband auction, the subband allocation control can be obtained by minimizing the original subband allocation Q-factor in Eqn. 13 over subband allocation actions. Using the approximate Q-factor, the subband allocation control can be given by

$${Ω}_{s}^{*} ( χ ) = arg {min}_{s} ( χ , s ) \approx arg {min}_{s} {\sum }_{k} {k}^{} ( {χ}_{k} , {s}_{k} ) .$$

This can be obtained via a per-stage subband auction with K bidders or mobiles stations (MSs) and one auctioneer or base station (BS) based on the observed realization of the system state at each MS χₖ. The Per-Stage Subband Auction among K MSs can be implemented, according to various aspects, as follows.

For example, for bidding, based on the local observation χₖ, each user k 122 can submit a bid { [symbol] ^{k}(χₖ,sₖ):∀sₖ}. In a further non-limiting example, for subband allocation, the BS 102 can assign one or more subbands to achieve the maximum sum bids, e.g.,

$${s}^{*} = {Ω}_{s}^{*} ( χ ) = arg {min}_{s} {\sum }_{k} {k}^{} ( {χ}_{k} , {s}_{k} ) \qquad ( 18 )$$

and can then broadcast the allocation results s*={sₖ*:∀k} to the K users 104. For power allocation, based on the subband allocation result sₖ*, each user k 122 can determine the transmit power, which can minimize the R.H.S. of Eqn. 17, e.g.,

$${p}_{k}^{*} = {Ω}_{{p}_{k}}^{*} ( χ ) = arg {min}_{{p}_{k}} [ {g}_{k} ( {γ}^{k} , {χ}_{k}^{i} , {s}_{k}^{*} , {p}_{k} ) + {\sum }_{{χ}_{k}^{j}} P r [ {χ}_{k}^{j} \vert {χ}_{k}^{i} , {s}_{k} , {p}_{k} ] {W}^{k} ( {χ}_{k}^{j} ) ] - {θ}^{k} \qquad ( 19 )$$

It should be noted that, according to non-limiting aspects, optimal subband and power allocation under Q-factor approximation employing proposed per-stage subband auction, the subband allocation actions can minimize

$${\sum }_{k} {k}^{} ( {χ}_{k} , {s}_{k} ) ,$$

and the power allocation actions at each MS or user k 122 can minimize the R.H.S. of the per-user subband allocation Q-factor fixed point equation in Eqn. 17. Therefore, the per-stage subband auction can achieve the solution of the Bellman equation in Eqn. 13 under the linear Q-factor approximation in Eqn. 16.

It is further noted regarding computational complexity and memory requirement reduction at the BS 102 that, with the per-stage subband auction mechanism, the BS 102 does not need to store the per-user subband allocation Q-factor { [symbol] ^{k}(χₖ,sₖ)} (∀k) and 2K LMs for all the MSs users 104, which can greatly reduce the memory requirement at the BS 102, according to various non-limiting aspects. As a further non-limiting advantage, on the other hand, the BS 102 does not need to perform power allocation for each MS on each subband p_{k,n}(∀k,n), which can significantly reduce the computational complexity at the BS 102.

In still further non-limiting aspects, according to an online per-user primal-dual learning algorithm via a stochastic approximation, because the derived power and subband allocation policies represent functions of the per-user subband allocation Q-factor and LMs, an online localized learning algorithm can estimate { [symbol] ^{k}(χₖ,sₖ)} and LMs γ^{k} at each MS k 122. For notation convenience, the per-user state-action combination can be denoted as φ [symbol] (χₖ,sₖ) (∀k). Let i and j (1≦i,j≦I_{φ}) be the dummy indices enumerating all the per-user state-action combinations of each user with cardinality I_{φ}=2^{N}^{_{F}}I_{χ}^{k}. Let [symbol] ^{k} [symbol] ( [symbol] ^{k}(φ¹), . . . , [symbol] ^{k}(φ^{I}^{_{φ}}))^{T} be the vector of per-user Q-factor for user k. Let φₖ(t) [symbol] (χₖ(t),sₖ(t)) be the state-action pair observed at MS k at the t-th slot, where χₖ(t)=(Qₖ(t),Hₖ(t)) can denote the system state realization observed at MS k 122. Based on the current observation φₖ(t), user k 122 can updates its estimate on the per-user Q-factor and the LMs according to:

[symbol]

ₜ₊₁^{k}(φⁱ)= [symbol] ₜ^{k}(φⁱ)+εₖ_{ₖ}_{(φ}_{ⁱ}_{,t)}^{q}[gₖ(γₜ^{k},φⁱ,pₖ(t))+\tilde{W}ₜ^{k}(Qₖ(t+1)))−(gₖ(γₜ^{k},φ^{r},pₖ( t̅))+\tilde{W}ₜ^{k}(Qₖ( t̅+1))− [symbol] ₜ^{k}(φ^{r}))− [symbol] ₜ^{k}(φⁱ)]1[φₖ(t)=φⁱ] (20)

$${\overline{γ}}_{t + 1}^{k} = Γ ( {\overline{γ}}_{t}^{k} + {ε}_{t}^{γ} ( {\sum }_{n} {p}_{k , n} ( t ) - {P}_{k} ) ) \qquad ( 21 )$$

γₜ₊₁^{k}=Γ(γₜ^{k}+εₜ^{γ}(1[Qₖ(t)=N_{Q}]−Pₖ^{d})) (22)

where

$${l}_{k} ( {ϕ}^{i} , t ) {=}^{Δ} {\sum }_{m = 0}^{t} 1 [ {ϕ}_{k} ( m ) = {ϕ}^{i} ]$$

represents the number of updates of [symbol] ^{k}(φⁱ) till t, pₖ(t)={p_{k,n}(t):∀n} denotes the power allocation actions given the per-stage auction, \tilde{W}ₜ^{k}( [symbol] ^{k}) [symbol] [symbol] [Wₜ^{k}(χₖ)| [symbol] ^{k}] with Wₜ^{k}(χₖ)= [symbol] [ [symbol] ₜ^{k}[ [symbol] ₖ,{s_{k,n}=1[|H_{k,n}|≧H_{K-1}*]})|χₖ], t̅ [symbol] sup{t:φₖ(t)=φ^{r}}, φ^{r} denotes the reference per-user state-action combination, Γ(.) is the projection onto an interval [0,B] for some B>0 and {εₜ^{q}},{εₜ^{γ}} are the step size sequences satisfying the following conditions:

$${\sum }_{t} {ε}_{t}^{q} = ∞ , {ε}_{t}^{q} \geq 0 , {ε}_{t}^{q} -> 0 , {\sum }_{t} {ε}_{t}^{γ} = ∞ , {ε}_{t}^{γ} \geq 0 , {ε}_{t}^{γ} -> 0 , \\ {\sum }_{t} ( {( {ε}_{t}^{q} )}^{2} + 2 {( {ε}_{t}^{γ} )}^{2} ) < ∞ , \frac{{ε}_{t}^{γ}}{{ε}_{t}^{q}} -> 0 \qquad ( 23 )$$

Note that without loss of generality, the per-user subband allocation Q-factor can be initialized as zero, e.g., [symbol] ₀^{k}(φ^{r})=0∀k . According to various non-limiting implementations of the disclosed subject matter, the above distributed per-user potential learning algorithm requires knowledge on local QSI and local CSI only. It is further noted that, in comparison to the deterministic network utility maximization (NUM), in conventional iterative solutions for deterministic NUM, the iterative updates (with message exchange) are performed within the CSI coherence time and hence, this limits the number of iterations and the performance. For instance, because the iterations within a CSI coherence time involve explicit message passing, there is processing and signaling overhead per iteration that can limit the total number of iterations within a CSI coherence time. However, in the online algorithm of various non-limiting implementations, the updates can evolve in the same time scale as the CSI and QSI. Thus, it can be understood that the various embodiments of the disclosed subject matter can converge to a better solution because the number of iterations is no longer limited by the coherence time of CSI.

Moreover, regarding comparison to conventional reinforced learning, various aspects of the per-user online update algorithms provide advantages over conventional techniques. As a non-limiting example, conventional online learning techniques typically address unconstrained MDP only. In the case of CMDP, the LM can be determined offline by simulation. In contrast, according to various non-limiting embodiments of the disclosed subject matter, both the LM and the per-user Q-factor are updated simultaneously. In a further non-limiting example, conventional online learning techniques are typically designed for centralized solutions where the control actions are determined entirely from the potential or Q-factor update. However, according to various non-limiting embodiments of the disclosed subject matter, the control actions for user k 122 can be determined from { [symbol] ^{k}(φ)} (∀k) via a per-stage auction. Moreover, during iterative updates, the per-user Q-factor, the LMs, and the control actions (e.g., power 118 and subband 120 allocation policies, etc.) can be changed dynamically and the existing convergence results (e.g., based on contraction mapping argument) may not be able to be applied directly to the distributed stochastic learning algorithm.

In the analysis of convergence of the online distributed learning algorithm, technical conditions for the almost-sure convergence of the online distributed learning algorithm can be established. For instance, for any LM γ (γ^{k}≧0), define a vector mapping T^{k}:R²×R^{I}^{_{φ}}→R^{I}^{_{φ}} for user k, and T^{k} [symbol] (T₁^{k}, . . . , T_{I}_{_{φ}}^{k})^{T} with the i-th (1≦i≦I_{φ}) component mapping defined as

$${T}_{i}^{k} ( {γ}^{k} , {k}^{} ) {=}^{Δ} {min}_{{p}_{k}} [ {g}_{k} ( {γ}^{k} , {ϕ}^{i} , {p}_{k} ) + {\sum }_{{ϕ}^{j}} Pr [ {ϕ}^{j} \vert {ϕ}^{i} , {p}_{k} ] {k}^{} ( {ϕ}^{j} ) ] ,$$

where

$$\begin{matrix}Pr [ {ϕ}^{j} \vert {ϕ}^{i} , {p}_{k} ] = Pr [ {χ}_{k}^{j} , {s}_{k}^{j} \vert {ϕ}^{i} , {p}_{k} ] \\ = Pr {χ}_{k}^{j} \vert {ϕ}^{i} , {p}_{k} ] Pr [ {s}_{k}^{j} \vert {χ}_{k}^{j} ] \\ = Pr [ {χ}_{k}^{j} \vert {ϕ}^{i} , {p}_{k} ] {\prod }_{n} Pr [ \begin{matrix}{s}_{k , n}^{j} ( \vert {H}_{k , n}^{j} \vert \geq {H}_{K - 1}^{*} ) + \\ ( 1 - {s}_{k , n}^{j} ) ( \vert {H}_{k , n}^{j} \vert < {H}_{K - 1}^{*} ) \vert {H}_{k , n}^{j}\end{matrix} ] .\end{matrix}$$

Define

Aₜ₋₁^{k} [symbol] Pₜ^{k}εₜ₋₁^{v}+(1−εₜ₋₁^{v})I,

Bₜ₋₁^{k} [symbol] Pₜ^{k}εₜ₋₁^{v}+(1−εₜ₋₁^{v})I (24)

where Pₜ^{k} denotes the I_{φ}×I_{φ} transition probability matrix with Pr[φ^{j}|φⁱ,pₜ^{k}(i)] as its (i,j)-element, pₜ^{k}(i) denotes the power allocation for φⁱ obtained by per-stage subband auction at the t-th iteration, and I denotes the I_{φ}×I_{φ} identity matrix.

Because there can be two different step size sequences {εₜ^{γ}} and {εₜ^{q}} and εₜ^{γ}=o(εₜ^{q}), the LM updates and the per-user Q-factor updates can be done simultaneously but over two different time scales. During the per-user Q-factor update (timescale I), γ̅ₜ₊₁^{k}− γ̅ₜ^{k}=e(t) and γₜ₊₁^{k}−γₜ^{k}=e(t) (∀k),

where e(t)= [symbol] (εₜ^{γ})=o(εₜ^{q}). Therefore, the LM can appear to be quasi-static during the per-user Q-factor update in Eqn. 20. Accordingly, the following lemma can be employed.

Lemma 2, convergence of per-user Q-factor learning over timescale I, assume for all the feasible policies Ω in the policy space, there exists a δₘ= [symbol] (εₘ^{q})>0 and some positive integer m such that

[Aₘ^{k} . . . Aₗ^{k}]ᵢᵣ≧δₘ, Bₘ^{k} . . . Bₗ^{k}]ᵢᵣ≧δₘ, 1≦i≦I_{φ} (25)

where [.]ᵢᵣ can denote the element of the i-th row with r-th column of the corresponding I_{φ}×I_{φ} matrix (r represents the column index in Pₜ^{k} which contains the aggregate reference state φ^{r}). For step size sequence {εₜ^{q}},{εₜ^{γ}} satisfying the conditions in Eqn. 23,

$${lim}_{t -> ∞} {t}_{k}^{} = {∞}_{k}^{} ( γ ) ∀ k$$

almost surely (a.s.) for any initial per-user subband allocation Q-factor vector [symbol] ₀^{k} and LM γ, where the converged per-user subband allocation Q-factor [symbol] _{∞}^{k}(γ) satisfies:

(Tᵣ^{k}(γ^{k}, [symbol] _{∞}^{k}(γ))− [symbol] _{∞}^{k}(φ^{r}))e+ [symbol] _{∞}^{k}(γ)=T^{k}(γ^{k}, [symbol] _{∞}^{k}(γ)) (26)

As proof of Lemma 2, because ∀k , each state-action pair φⁱ can be updated comparably often, the only difference between the synchronous update and asynchronous update can be that the resultant ordinary differential equation (ODE) of the asynchronous update is a time-scaled version of the synchronous update. However, it does not affect the convergence behavior. Therefore, the convergence of related synchronous version for simplicity can be considered in the following.

Due to symmetry, the update for user k can be considered. It can be proved that the synchronous version of the per-user Q-factor update in Eqn. 20 can be equivalent to the per-user Q-factor update given by

[symbol]

ₜ₊₁^{k}(φⁱ)= [symbol] ₜ^{k}(φⁱ)+εₜ^{q}Yₜ^{k}(γ^{k},φⁱ) 1≦i≦I^{φ} (27)

where Yₜ^{k}(γ^{k},φⁱ)=gₖ(γ^{k},φⁱ,p^{k}(t))+\tilde{W}ₜ^{k}(Qₖ(t+1))−(gₖ(γ^{k},φ^{r},p^{k}( t̅))+\tilde{W}ₜ^{k}( Q̅ₖ^{r})− [symbol] ₜ^{k}(φ^{r}))− [symbol] ₜ^{k}(φⁱ).

Denote Yₜ^{k} [symbol] (γₜ^{k}(γ^{k},φ¹), . . . , Yₜ^{k}(γ^{k},φ^{I}^{_{φ}}))^{T}. Let [symbol] ₜ [symbol] ( [symbol] ₜ¹, . . . , [symbol] ₜ^{K}) and Yₜ [symbol] (Yₜ¹, . . . , Yₜ^{K}) be the aggregate vector of per-user Q-factor and Yₜ^{k} (aggregate across all K users in the system). The proof can proceed by first establishing the convergence of the martingale noise in the Q-factor update dynamics. Let [symbol] ₜ and

$${Pr}_{t}$$

denote the expectation and probability conditioned on the σ-algebra [symbol] ₜ, generated by { [symbol] ₀,Yᵢ,i<t}, e.g., [symbol] ₜ[.]= [symbol] [.| [symbol] ₜ] and

$${Pr}_{t} [ \cdot ] = Pr [ \cdot \vert {t}_{} ] .$$

Define Rₜ^{k}(γ^{k},φⁱ) [symbol] [symbol] ₜ[Yₜ^{k}(γ^{k},φⁱ)]=Tᵢ^{k}(γ^{k}, [symbol] ₜ^{k})− [symbol] ₜ^{k}(φⁱ)−(Tᵣ^{k}(γ^{k}, [symbol] ₜ^{k})− [symbol] ₜ^{k}(φ^{r})) and δMₜ^{k}(φⁱ) [symbol] Tₜ^{k}(γ^{k},φⁱ)− [symbol] ₜ[Yₜ^{k}(γ^{k},φⁱ)]. Thus, δMₜ^{k}(φ¹) is the martingale difference noise satisfying the property that [symbol] ₜ[δMₜ^{k}(φⁱ)]=0 and [symbol] [δMₜ^{k}(φⁱ)δM_{t′}^{k}(φⁱ)]=0 (∀t≠t′). For some j, define

$${M}_{t}^{k} ( {ϕ}^{i} ) = {\sum }_{l = j}^{t} {ε}_{l}^{q} δ {M}_{l}^{k} ( {ϕ}^{i} ) .$$

Then, from Eqn. 27, it follows that

$$\begin{matrix}{t + 1}_{k}^{} ( {ϕ}^{i} ) = {t}_{k}^{} ( {ϕ}^{i} ) + {ε}_{t}^{q} ( {R}_{t}^{k} ( {γ}^{k} , {ϕ}^{i} ) + δ {M}_{t}^{k} ( {ϕ}^{i} ) ) \\ = {j}_{k}^{} ( {ϕ}^{i} ) + {\sum }_{l = j}^{t} {ε}_{l}^{q} {R}_{l}^{k} ( {γ}^{k} , {ϕ}^{i} ) + {M}_{t}^{k} ( {ϕ}^{i} )\end{matrix} \qquad ( 28 )$$

Since [symbol] ₜ [Mₜ^{k}(φⁱ)]=Mₜ₋₁^{k}(φⁱ), Mₜ^{k}(φⁱ) is a Martingale sequence. By martingale inequality, it follows that

$${Pr}_{j} \{ {sup}_{j \leq l \leq t} \vert {M}_{l}^{k} ( {ϕ}^{i} ) \vert \geq λ \} \leq \frac{{j}_{} [ {\vert {M}_{t}^{k} ( {ϕ}^{i} ) \vert}^{2} ]}{{λ}^{2}} .$$

By the property of martingale difference noise and the condition on the step size sequence, it follows
that

$$\begin{matrix}{j}_{} [ {\vert {M}_{t}^{k} ( {ϕ}^{i} ) \vert}^{2} ] = {j}_{} [ {\vert {\sum }_{l = j}^{t} {ε}_{l}^{q} δ {M}_{l}^{k} ( {ϕ}^{i} ) \vert}^{2} ] \\ = {\sum }_{l = j}^{t} \end{matrix}$$

where M̅=max_{j≦l≦t}(δMₗ^{k}(φⁱ))²<∞. Hence, it follows
that

$${lim}_{j -> ∞} {Pr}_{j} \{ {sup}_{j \leq l \leq t} \vert {M}_{l}^{k} ( {ϕ}^{i} ) \vert \geq λ \} -> 0.$$

Thus, from Eqn. 28,

$${t + 1}_{k}^{} ( {ϕ}^{i} ) = {j}_{k}^{} ( {ϕ}^{i} ) + {\sum }_{l = j}^{t} {ε}_{l}^{q} {R}_{l}^{k} ( {γ}^{k} , {ϕ}^{i} )$$

a.s. with the vector form

$${t + 1}_{k}^{} = {j}_{k}^{} + {\sum }_{l = j}^{t} {ε}_{l}^{q} {R}_{l}^{k} \qquad ( 29 )$$

where Rₗ^{k}=T^{k}(γ^{k}, [symbol] ₗ^{k})− [symbol] ₗ^{k}−(Tᵣ^{k}(γ^{k}, [symbol] ₗ^{k})− [symbol] ₗ^{k}(φ^{r}))e and e=[1, . . . , 1]^{T} denote the I_{φ}×1 unit vector.

Next, the convergence of the dynamic equation in Eqn. 29 can be established after the martingale noise is averaged out. Let gₜ^{k} and Pₜ^{k} denote the cost column vector and the transition probability matrix under the power allocation pₜ^{k}, which attains the minimum of T^{k} of the t-Th iteration.

Denote zₜ^{k}=Tᵣ^{k}(γ^{k}, [symbol] ₜ^{k})− [symbol] ₜ^{k}(φ^{r}). Then, it follows that

$${R}_{t}^{k} = {g}_{t}^{k} + {P}_{t}^{k} {t}_{k}^{} - {t}_{k}^{} - {z}_{t}^{k} e \leq {g}_{t - 1}^{k} + {P}_{t - 1}^{k} {t}_{k}^{} - {t}_{k}^{} - {z}_{t}^{k} e$$

$${R}_{t - 1}^{k} = {g}_{t - 1}^{k} + {P}_{t - 1}^{k} {t - 1}_{k}^{} - {t - 1}_{k}^{} - {z}_{t - 1}^{k} e \leq {g}_{t}^{k} + {P}_{t}^{k} {t - 1}_{k}^{} - {t - 1}_{k}^{} - {z}_{t - 1}^{k} e \\ ⇒ {A}_{t - 1}^{k} {R}_{t - 1}^{k} - ( {z}_{t}^{k} - {z}_{t - 1}^{k} ) e \leq {R}_{t}^{k} \leq {B}_{t - 1}^{k} {R}_{t - 1}^{k} - ( {z}_{t}^{k} - {z}_{t - 1}^{k} ) e , \\ ∀ k \geq 1 by iterating \\ ⇒ {A}_{t - 1}^{k} … {A}_{t - m}^{k} {q}_{t - m}^{k} - ( {z}_{t}^{k} - {z}_{t - m}^{k} ) e \leq {R}_{t}^{k} \leq {B}_{t - 1}^{k} … {B}_{t - m}^{k} {q}_{t - m}^{k} - ( {z}_{t}^{k} - {z}_{t - m}^{k} ) e$$

Since Rₜ^{k}(γ^{k},φ^{r})=Tᵣ^{k}(γ^{k}, [symbol] ₜ^{k})− [symbol] ₜ^{k}(φ^{r})−(Tᵣ^{k}(γ^{k}, [symbol] ₜ^{k})− [symbol] ₜ^{k}(φ^{r}))=0 ∀t, by Eqn. 25, it follows that

$$( 1 - {δ}_{m} ) {min}_{{i}^{′}} {R}_{t - m}^{k} ( {γ}^{k} , {ϕ}^{{i}^{′}} ) - ( {z}_{t}^{k} - {z}_{t - m}^{k} ) \leq {R}_{t}^{k} ( {γ}^{k} , {ϕ}^{i} ) \leq ( 1 - {δ}_{m} ) {max}_{{i}^{′}} {R}_{t - m}^{k} ( {γ}^{k} , {ϕ}^{{i}^{′}} ) - ( {z}_{t}^{k} - {z}_{t - m}^{k} ) ∀ i ⇒ \{ \begin{matrix}{min}_{{i}^{′}} {R}_{t}^{k} ( {γ}^{k} , {ϕ}^{{i}^{′}} ) \geq ( 1 - {δ}_{m} ) {min}_{{i}^{′}} {R}_{t - m}^{k} ( {γ}^{k} , {ϕ}^{i} ) \\ - ( {z}_{t}^{k} - {z}_{t - m}^{k} ) \\ {max}_{{i}^{′}} {R}_{t}^{k} ( {γ}^{k} , {ϕ}^{{i}^{′}} ) \leq ( 1 - {δ}_{m} ) {max}_{{i}^{′}} {R}_{t - m}^{k} ( {γ}^{k} - {ϕ}^{{i}^{′}} ) \\ - ( {z}_{t}^{k} - {z}_{t - m}^{k} )\end{matrix} ⇒ {max}_{{i}^{′}} {R}_{t}^{k} ( {γ}^{k} , {ϕ}^{{i}^{′}} ) - {min}_{{i}^{′}} {R}_{t}^{k} ( {γ}^{k} , {ϕ}^{{i}^{′}} ) \leq ( 1 - {δ}_{m} ) ( {max}_{{i}^{′}} {R}_{t - m}^{k} ( {γ}^{k} , {ϕ}^{{i}^{′}} ) - {min}_{{i}^{′}} {R}_{t - m}^{k} ( {γ}^{k} , {ϕ}^{{i}^{′}} ) ) ⇒ {max}_{{i}^{′}} {R}_{t}^{k} ( {γ}^{k} , {ϕ}^{{i}^{′}} ) - {min}_{{i}^{′}} {R}_{t}^{k} ( {γ}^{k} , {ϕ}^{{i}^{′}} ) \leq {φ}_{j} {\prod }_{l = 1}^{⌊ \frac{t - j}{m} ⌋} ( 1 - {δ}_{j + l m} )$$

where φⱼ>0. Since Rₜ^{k}(γ^{k},φ^{r})=0 ∀t, it follows that max_{i′}Rₜ^{k}(γ^{k},φⁱ′)≧0 and min_{i′}Rₜ^{k}(γ^{k},φⁱ′)≦0. Thus, ∀i , it follows
that

$$\vert {R}_{t}^{k} ( {γ}^{k} , {ϕ}^{i} ) \vert \leq {max}_{{i}^{′}} {R}_{t}^{k} ( {γ}^{k} , {ϕ}^{{i}^{′}} ) - {min}_{{i}^{′}} {R}_{t}^{k} ( {γ}^{k} , {ϕ}^{{i}^{′}} ) \leq {φ}_{j} {\prod }_{l = 1}^{⌊ \frac{t - j}{m} ⌋} ( 1 - {δ}_{j + l m} ) .$$

Therefore, as t→∞, Rₜ^{k}→0, e.g., [symbol] _{∞}^{k}(γ) satisfies the equation in Eqn. 26. Similar to the potential function of Bellman equation, the solution to Eqn. 26 is unique only up an additive constant. Since [symbol] ₗ^{k}(φ^{r})= [symbol] ₀^{k}(φ^{r}) ∀t, it follows that have the convergence of the per-user subband allocation Q-factor

$${lim}_{l \to ∞} {𝒬}_{t}^{k} = {𝒬}_{∞}^{k} ( γ )$$

almost surely.

On the other hand, during the LM update (timescale II),

$${lim}_{t \to ∞} ‖ {𝒬}_{t}^{k} - {𝒬}_{∞}^{k} ( {γ}_{t} ) ‖ = 0$$

with probability one (w.p.1) as is shown elsewhere. Hence, during the LM updates in Eqn. 21 and Eqn. 22, the per-user subband allocation Q-factor update can be seen as almost equilibrated. The convergence of the LM can be summarized as follows in Lemma 3 and the proof thereof.

Lemma 3, convergence of the LM over timescale II, the iterates

$${lim}_{t \to ∞} {γ}_{t} = {γ}_{∞} a . s . ,$$

where γ_{∞} satisfies the power and packet drop rate constraints in Eqn. 9 and Eqn. 10.

As proof of Lemma 3, due to the separation of time scale, the primal update of the Q-factor can be regarded as converged to [symbol] _{∞}^{k}(γₜ) with respect to the current LMs γₜ. Using standard stochastic approximation theorem, the dynamics of the LMs update equation in Eqns. 21 and 22 can be represented by the following ODE:

$$\dot{γ} ( t ) = {{𝔼}^{{Ω}^{*} ( γ ( t ) )} [ \begin{matrix}( {\sum }_{n} {p}_{1 , n} - {P}_{1} ) , ( 1 [ {Q}_{k} = {N}_{Q} ] - {P}_{1}^{d} ) , … \\ ( {\sum }_{n} {p}_{K , n} - {P}_{K} ) , ( 1 [ {Q}_{K} = {N}_{Q} ] - {P}_{K}^{d} )\end{matrix} ]}^{T} \qquad ( 30 )$$

where Ω*(γ(t))=(Ωₚ*(γ(t)),Ωₛ*(γ(t))) is the converged control policies in Eqns. 19 and 18 with respect to the current LM γ(t), and [symbol] ^{Ω}*^{(γ(t))}[.] denotes the expectation with respect to the measure induced by Ω*(γ).

### Define

$$G ( γ ) = {𝔼}^{{Ω}^{*} ( γ )} [ {\sum }_{k} {g}_{k} ( {γ}^{k} , {χ}_{k}^{i} , {s}_{k} , {p}_{k} ) ] .$$

Since subband allocation policy can be discrete, it follows that Ωₛ*(γ)=Ωₛ*(γ+δ_{γ}). Hence, by chain rule, it follows that

$$\frac{\partial G}{\partial {\overline{γ}}^{k}} = {\sum }_{k , n} \frac{\partial G}{\partial {p}_{k , n}^{*}} \frac{\partial {p}_{k , n}^{*}}{\partial {\overline{γ}}^{k}} + {𝔼}^{( {Ω}_{p}^{*} ( γ ) , {Ω}_{s}^{*} ( γ ) )} [ {\sum }_{n} {p}_{k , n}^{*} - {P}_{k} ] .$$

### Since

$${Ω}_{p}^{*} ( γ ) = arg {min}_{{Ω}_{p} ( γ )} {𝔼}^{( {Ω}_{s}^{*} ( γ ) , {Ω}_{p} ( γ ) )} [ {\sum }_{k} {g}_{k} ( {γ}^{k} , {χ}_{k}^{i} , {s}_{k}^{*} , {p}_{k} ) ] ,$$

it follows that

$$\frac{\partial G}{\partial {\overline{γ}}^{k}} = 0 + {𝔼}^{( {Ω}_{p}^{*} ( γ ) , {Ω}_{s}^{*} ( γ ) )} [ {\sum }_{n} {p}_{k , n}^{*} - {P}_{k} ] = {\dot{\overline{γ}}}^{k} ( t ) .$$

### Similarly,

$$\frac{\partial G}{\partial {\underline{γ}}^{k}} = {𝔼}^{( {Ω}_{p}^{*} ( γ ) , {Ω}_{s}^{*} ( γ ) )} [ 1 [ {Q}_{k} = {N}_{Q} ] - {P}_{k}^{d} ] = \dot{{\underline{γ}}^{k}} ( t ) .$$

Therefore, we show that the ODE in Eqn. 30 can be expressed as γ(t)=∇G(γ(t)). As a result, the ODE in Eqn. 30 will converge to ∇G(γ)=0, which corresponds to Eqns. 9 and 10.

Based on the above lemmas, the convergence performance of the online per-user Q-factor and LM learning algorithm can be summarized in Theorem 1.

Theorem 1, convergence of online per-user learning algorithm, For the same conditions as in Lemma 2, ( [symbol] ₜ^{k},γₜ^{k})→( [symbol] _{∞}^{k},γ_{∞}^{k}) a.s. ∀k , where [symbol] _{∞}^{k}(γ_{∞}) and γ_{∞} satisfy

(Tᵣ^{k}(γ_{∞}^{k}, [symbol] _{∞}^{k})− [symbol] _{∞}^{k}(φ^{r}))e+ [symbol] _{∞}^{k}=T^{k}(γ_{∞}^{k} [symbol] _{∞}^{k}) (31)

and γ_{∞} satisfies the power and packet drop rate constraints in Eqn. 9 and Eqn. 10.
Application to OFDMA Systems with Exponential Packet Size Distribution

According to further non-limiting aspects, various non-limiting aspects of the disclosed subject matter (e.g., stochastic learning algorithms, etc.) can be employed in uplink OFDMA systems 100 with exponential packet size distribution. To illustrate dynamics of system 100 state under exponential distributed packet size, let A(t)=(A₁(t), . . . , A_{K}(t)) and N(t)=(N₁(t), . . . , N_{K}(t)) denote random new packet arrivals and the packet sizes for the K users 104 at the t-th scheduling slot, respectively. Q(t)=(Q₁(t), . . . , Q_{K}(t)) and N_{Q} can denote the joint QSI (number of packets) 114 at the end of the t-th scheduling slot and the maximum buffer size (number of packets).

Assumption 3: The arrival process Aₖ(t) can be assumed to be i.i.d. over scheduling slots according to a general distribution Pr(Aₖ) with average arrival rate [symbol] [Aₖ]=λₖ. In addition, the random packet size Nₖ(t) can be assumed to be i.i.d. over scheduling slots following an exponential distribution with mean packet size N̅ₖ.

Given a stationary policy, the conditional mean departure rate of packets of user k 122 at the t-th slot (conditioned on χ(t)) can be defined as μₖ(χ(t))=Rₖ(χ(t))/ N̅ₖ.

Assumption 4: The slot duration τ can be assumed to be sufficiently small compared with the average packet service time, e.g., μₖ(χ(t))τ<<1.

It is noted that this assumption can be understood to be reasonable in practical systems. For instance, in the uplink (UL) WiMAX™ (with multiple UL users served simultaneously), the minimum resource block that could be allocated to a user in the UL is 8×16 symbols−12 pilot symbols=116 symbols. Even with 64 Quadrature Amplitude Modulation (QAM) and rate ½ coding, the number of payload bits it can carry is 116×3 bits=348 bits. As a result, when there are many UL users sharing the WiMAX™ access point (AP), there could be cases that the Moving Picture Experts Group (MPEG) standard MPEG-4 packet (around 10,000 bits) from an UL user cannot be delivered in one frame. In addition, the delay requirement of MPEG-4 is 500 milliseconds (ms) or more, while the frame duration of WiMAX™ is 5 ms. Thus, it is not necessary to serve one packet during one scheduling slot so that the scheduler has more flexibility in allocating resource. Therefore, in practical systems, an application level packet may have mean packet length spanning over many time slots (frames) as is typically assumed in conventional understanding.

Given the current system state χ(t) and the control action, and conditioned on the packet arrival A(t) at the end of the t-th slot, there can be a packet departure of the k-th user 122 at the (t+1)-th slot if the remaining service time of a packet is less than the current slot duration τ. By the memoryless property of the exponential distribution, the remaining packet length (also denoted as N(t)) at any slot t can also be exponentially distributed. Thus, the transition probability to Qₖ(t+1) at the (t+1)-th slot corresponding to a packet departure event can be given by:

$$\begin{matrix}Pr [ {Q}_{k} ( t + 1 ) = {A}_{k} ( t ) + {Q}_{k} ( t ) - 1 \vert χ ( t ) , A ( t ) , Ω ( χ ( t ) ) ] \\ = Pr [ \frac{{N}_{k} ( t )}{{R}_{k} ( t )} < τ \vert χ ( t ) , A ( t ) , Ω ( χ ( t ) ) ] \\ = Pr [ \frac{{N}_{k} ( t )}{\overline{{N}_{k}}} < {μ}_{k} ( χ ( t ) ) τ ] \\ = 1 - exp ( - {μ}_{k} ( χ ( t ) ) τ ) \\ \approx {μ}_{k} ( χ ( t ) ) τ\end{matrix} \qquad ( 32 )$$

where the last equality is due to Assumption 4. Note that, because Nₖ(t) can be exponentially distributed and memoryless, the probability in Eqn. 32 (conditioned on the current state χ(t) and the associated action Ω(χ(t))) independent of the previous states {χ(t−1), χ(t−2), . . . } can result. Note further that the probability for simultaneous departure of two or more packets from the same queue or different queues in a slot can be [symbol] ((μₖ(χ(t))τ)²), which can be expected to be asymptotically negligible. Therefore, the vector queue dynamics can be expected to be Markovian with the transition probability given by

$$Pr [ Q ( t + 1 ) \vert χ ( t ) , Ω ( χ ( t ) ) ] = {\sum }_{k} Pr [ A ( t ) = Q ( t + 1 ) - Q ( t ) + {e}_{k} ] {μ}_{k} ( χ ( t ) ) τ + Pr [ A ( t ) = Q ( t + 1 ) - Q ( t ) ] ( 1 - {\sum }_{k} {μ}_{k} ( χ ( t ) ) τ ) \qquad ( 33 )$$

where eₖ can denote the standard basis vector with 1 for its k-th component and 0 for every other component.

In the following lemma, the per-user subband allocation Q-factor [symbol] ^{k}(χₖ,sₖ) can be shown to be further decomposable into the sum of per-user per-subband Q-factor, which can further simplify the learning algorithm, according to a further non-limiting aspect of the disclosed subject matter.

Lemma 4, decomposition of per-user Q-factor, the per-user Q-factor [symbol] ^{k}(χₖ,sₖ) (which can be defined by the fixed point equation in Eqn. 17) can be decomposed into the sum of the per-user per-subband Q-factor {q^{k}(Q,|H|,s)}, e.g.,

$${𝒬}^{k} ( {χ}_{k} , {s}_{k} ) = {\sum }_{n} {q}^{k} ( {Q}_{k} , \vert {H}_{k , n} \vert , {s}_{k , n} ) ,$$

where

$$\begin{matrix}{q}^{k} ( {Q}_{k} \vert {H}_{k , n} \vert , {s}_{k , n} ) {=}^{Δ} {min}_{{p}_{k , n}} \{ {g}_{k , n} ( {γ}^{k} , {Q}_{k} , \vert {H}_{k , n} \vert , {s}_{k , n} {p}_{k , n} ) - \frac{{N}_{F} δ {\tilde{w}}^{k} ( {Q}_{k} ) τ}{\overline{{N}_{k}}} {s}_{k , n} log ( 1 + {p}_{k , n} {\vert {H}_{k , n} \vert}^{2} ) + 𝔼 [ {\tilde{w}}^{k} ( {Q}_{k} + {A}_{k} ) \vert {Q}_{k} ] - \frac{{θ}^{k}}{{N}_{F}} & ( 34 ) \\ {g}_{k , n} ( {γ}^{k} , {Q}_{k} , \vert {H}_{k , n} \vert , {s}_{k , n} , {p}_{k , n} ) = {\overline{γ}}^{k} {p}_{k , n} + \frac{1}{{N}_{F}} ( {β}_{k} f ( {Q}_{k} ) - {\overline{γ}}^{k} {P}_{k} + {\underline{γ}}^{k} ( 1 [ {Q}_{k} = {N}_{Q} ] - {P}_{k}^{d} ) ) & ( 35 )\end{matrix}$$

\tilde{w}^{k}(Qₖ)= [symbol] [q^{k}(Q^{k},|K_{k,n}|,s_{k,n}=1[|H_{k,n}|≧K_{K-1}*])|Qₖ] (36)

δ\tilde{w}^{k}(Qₖ)= [symbol] [\tilde{w}^{k}(Qₖ+Aₖ)−\tilde{w}^{k}(Qₖ+Aₖ−1)|Qₖ] (37)

Furthermore, \tilde{W}^{k}(Qₖ)=N_{F}\tilde{w}^{k}(Qₖ).

As proof of Lemma 4, it follows

$$Let {q}^{k} ( {Q}_{k} , \vert {H}_{k , n} \vert , {s}_{k , n} ) = {min}_{{p}_{k , n}} \{ {g}_{k , n} ( {γ}^{k} , {Q}_{k} , \vert {H}_{k , n} \vert , {s}_{k , n} , {p}_{k , n} ) - \frac{Δ {\tilde{W}}^{k} ( {Q}_{k}^{i} ) τ}{\overline{{N}_{k}}} {s}_{k , n} log ( 1 + {p}_{k , n} {\vert {H}_{k , n} \vert}^{2} ) + \frac{𝔼 [ {\tilde{W}}^{k} ( {Q}_{k}^{i} + {A}_{k} ) \vert {Q}_{k} ]}{{N}_{F}} - \frac{{θ}^{k}}{{N}_{F}} \} \qquad ( 38 )$$

where \tilde{W}^{k}(Qₖ) [symbol] [symbol] [W^{k}(χₖ)|Qₖ] and
Δ\tilde{W}^{k}(Qₖ)= [symbol] [\tilde{W}^{k}(Qₖ+Aₖ)−\tilde{W}^{k}(Qₖ+Aₖ−1)|Qₖ]. Then, it follows that [symbol] Thus, we can derive

$$\begin{matrix}{W}^{k} ( {χ}_{k} ) = 𝔼 [ {k}^{} ( {χ}_{k} , \{ {s}_{k , n} = 1 [ \vert {H}_{k , n} \vert \geq {H}_{K - 1}^{*} ] \} ) \vert {χ}_{k} ] \\ = 𝔼 [ {\sum }_{n} {q}^{k} ( {k}_{} , \vert {H}_{k , n} \vert , {s}_{k , n} = 1 [ \vert {H}_{k , n} \vert \geq {H}_{K - 1}^{*} ] ) \vert {χ}_{k} ] \\ = {\sum }_{n} \underbrace{ 𝔼 [ {q}^{k} ( {Q}_{k} , \vert {H}_{k , n} \vert , {s}_{k , n} = 1 [ \vert {H}_{k , n} \vert \geq {H}_{K - 1}^{*} ] ) \vert {Q}_{k} , {H}_{k , n} ]}_{{w}^{k} ( {Q}_{k} , \vert {H}_{k , n} \vert )} ⇒ \\ {\tilde{W}}^{k} ( {Q}_{k} ) \\ = 𝔼 [ {W}^{k} ( {χ}_{k} ) \vert {Q}_{k} ] \\ = 𝔼 [ {\sum }_{n} {w}^{k} ( {Q}_{k} , \vert {H}_{k , n} \vert ) \vert {Q}_{k} ] \\ = {\sum }_{n} \underbrace{𝔼 [ {w}^{k} ( {Q}_{k} , \vert {H}_{k , n} \vert ) \vert {Q}_{k} ]}_{{\tilde{w}}^{k} ( {Q}_{k} )} \\ = {N}_{F} {\tilde{w}}^{k} ( {Q}_{k} ) ⇒ \\ Δ {\tilde{W}}^{k} ( {Q}_{k} ) \\ = 𝔼 [ {\tilde{W}}^{k} ( {Q}_{k} + {A}_{k} ) - {\tilde{W}}^{k} ( {Q}_{k} + {A}_{k} - 1 ) \vert {Q}_{k} ] \\ = {N}_{F} \underbrace{𝔼 [ {\tilde{w}}^{k} ( {Q}_{k} + {A}_{k} ) - {\tilde{w}}^{k} ( {Q}_{k} + {A}_{k} - 1 ) \vert {Q}_{k} ]}_{δ {\tilde{w}}^{k} ( {Q}_{k} )}\end{matrix}$$

Therefore, from Eqn. 38, Eqn. 34 can be obtained.

Based on the per-user per-subband Q-factor {q^{k}(Q,|H|,s)}, the closed-form power allocation actions minimizing the R.H.S. of the per-user subband allocation Q-factor fixed point equation in Eqn. 17 can be obtained, which can be summarized in the following lemma:

Lemma 5, decentralized power control actions, given subband allocation actions sₖ, the optimal power control actions of user k under the linear approximation on subband allocation Q-factor in Eqn. 16 can be given by

$${p}_{k , n} ( {Q}_{k} , {H}_{k , n} ) = {{s}_{k , n} ( \frac{\frac{τ}{{\overline{N}}_{k}} {N}_{F} δ {\tilde{w}}^{k} ( {Q}_{k} )}{{\overline{γ}}^{k}} - \frac{1}{{\vert {H}_{k , n} \vert}^{2}} )}^{+} , ∀ n \qquad ( 39 )$$

As proof of Lemma 5, the conditional transition probability of user k is given by Pr[χₖ^{j}|χₖⁱ,sₖ,pₖ]=Pr[Hₖ^{j}]Pr[Qₖ^{j}|χₖⁱ,sₖ, pₖ],

where Pr[Qₖ^{j}|χₖⁱsₖ,pₖ]=

$$Pr [ {A}_{k} = {Q}_{k}^{j} - {Q}_{k}^{i} + 1 ] {μ}_{k} ( {χ}_{k}^{i} , {s}_{k} , {p}_{k} ) τ + Pr [ {A}_{k} = {Q}_{k}^{j} - {Q}_{k}^{i} ] ( 1 - {μ}_{k} ( {χ}_{k}^{i} , {s}_{k} , {p}_{k} ) τ ) . \\ {k}^{} ( {χ}_{k}^{i} , {s}_{k} ) {=}^{( a )} {min}_{{p}_{k}} [ {g}_{k} ( {γ}^{k} , {χ}_{k}^{i} , {s}_{k} , {p}_{k} ) + {\sum }_{{H}_{k}^{j} , {Q}_{k}^{j}} Pr [ {H}_{k}^{j} ] Pr [ {Q}_{k}^{j} \vert {χ}_{k}^{i} , {s}_{k} , {p}_{k} ] {W}^{k} ( {χ}_{k}^{j} ) ] - {θ}^{k} {=}^{( b )} {min}_{{p}_{k}} [ {g}_{k} ( {γ}^{k} , {χ}_{k}^{i} , {s}_{k} , {p}_{k} ) + {\sum }_{{Q}_{k}^{j}} Pr [ {Q}_{k}^{j} \vert {χ}_{k}^{i} , {s}_{k} , {p}_{k} ] {\tilde{W}}^{k} ( {Q}_{k}^{j} ) ] - {θ}^{k} = {min}_{{p}_{k}} [ {g}_{k} ( {γ}^{k} , {χ}_{k}^{i} , {s}_{k} , {p}_{k} ) + ( 1 - {μ}_{k} ( {χ}_{k}^{i} , {s}_{k} , {p}_{k} ) τ ) 𝔼 [ {\tilde{W}}^{k} ( {Q}_{k}^{i} + {A}_{k} ) \vert {Q}_{k} ] + {μ}_{k} ( {χ}_{k}^{i} , {s}_{k} , {p}_{k} ) τ𝔼 [ {\tilde{W}}^{k} ( {Q}_{k}^{i} + {A}_{k} - 1 ) \vert {Q}_{k} ] ] - {θ}_{k} {⇔}^{( d )} {min}_{{p}_{k}} {\overline{γ}}^{k} {\sum }_{n} {p}_{k , n} - \frac{Δ {\tilde{W}}^{k} ( {Q}_{k} ) τ}{\overline{{N}_{k}}} ( {\sum }_{n} {s}_{k , n} log ( 1 + {p}_{k , n} {\vert {H}_{k , n} \vert}^{2} ) ) \qquad ( 40 )$$

where (a) is due to Eqn. 17 and the above per-user transition probability, (b) is due to the definition \tilde{W}^{k}(Qₖ) [symbol] [symbol] [W^{k}(χₖ)|Qₖ] and (d) is due to the definition Δ\tilde{W}^{k}(Qₖ)= [symbol] [\tilde{W}^{k}(Qₖ+Aₖ)−\tilde{W}^{k}(Qₖ+Aₖ−1)|Qₖ]. By applying standard convex optimization techniques and Lemma 4 (Δ\tilde{W}^{k}(Qₖ)=N_{F}δ\tilde{w}^{k}(Qₖ)), the optimal solution to Eqn. 40 is given by Eqn. 39.

It can be noted that in a multi-level water-filling structure of the power control action, the power control action in Eqn. 39 of Lemma 5 is both function of the CSI and QSI (where it can depend on the QSI indirectly via δ\tilde{w}^{k}(Qₖ), which can be function of {q^{k}(Q,|H|, s)}). Moreover, according to a non-limiting aspect, it can have the form of a multi-level water-filling structure where the power is allocated according to the CSI across subbands with the water level adaptive to the QSI as previously described.

FIG. 2 depicts a non-limiting flowchart of an exemplary algorithm of an online distributed primal-dual value iteration algorithm with per-stage auction and simultaneous updates on potential and Lagrange multipliers, according to various non-limiting implementations of the disclosed subject matter. Note that t={0, 1, 2, . . . } can denote the scheduling slot index.

For example, applying a per-stage subband auction as described above to the system dynamics setup as described herein, a low computational complexity and signaling overhead can be obtained. Scalarized per-subband auction (∀nε{1,N_{F}}) as illustrated in FIG. 2, which can be based on the per-user subband allocation Q-factor decomposition in Lemma 4 and the closed-form power allocation actions in Lemma 5 can be described for various non-limiting implementations as follows.

Bidding: For the n-th subband, each user can submit a bid

$${X}_{k , n} = \frac{{N}_{F} δ {\tilde{w}}^{k} ( {Q}_{k} ) τ}{\overline{{N}_{k}}} log ( 1 + {\vert {H}_{k , n} \vert}^{2} {( \frac{\frac{{N}_{F} δ {\tilde{w}}^{k} ( {Q}_{k} ) τ}{\overline{{N}_{k}}}}{{\overline{γ}}^{k}} - \frac{1}{{\vert {H}_{k , n} \vert}^{2}} )}^{+} ) {{\overline{γ}}^{k} ( \frac{\frac{{N}_{F} δ {\tilde{w}}^{k} ( {Q}_{k} ) τ}{\overline{{N}_{k}}}}{{\overline{γ}}^{k}} - \frac{1}{{\vert {H}_{k , n} \vert}^{2}} )}^{+}$$

Subband Allocation: The BS 102 can assign the n-th subband according to the highest bid:

$${s}_{k , n}^{*} ( {H}_{n} , Q ) = \{ \begin{matrix}1 , & if k = {k}_{n}^{*} and {X}_{{k}_{n}^{*} , n} > 0 \\ 0 , & otherwise\end{matrix} \qquad ( 41 )$$

where kⁿ*=arg maxₖX_{k,n} can denote the user with the highest bid and then broadcasts the allocation results to K users 104.

Power Allocation: Each user can determine the transmit power according to:

$${p}_{k , n}^{*} ( {H}_{n} , Q ) = {s}_{k , n}^{*} ( {H}_{n} , Q ) {( \frac{\frac{τ}{{\overline{N}}_{k}} {N}_{F} δ {\tilde{w}}^{k} ( {Q}_{k} )}{{\overline{γ}}^{k}} - \frac{1}{{\vert {H}_{k , n} \vert}^{2}} )}^{+} \qquad ( 42 )$$

It should be noted that, in a comparison to brute-force (CSI, QSI)-feedback schemes, each mobile station (MS) or user k would feedback CSI|H_{k,n}|(∀n), QSI Qₖ and the LM, γₖ. In addition, BS 102 would solve the subband allocation s_{k,n}* and power allocation p_{k,n}*, and would broadcast the (real number) power allocation p_{k,n}* to the MSs or users 104. Note that for the signaling from MS or user to BS 102, quantization bits used in signaling for the bid X_{k,n} versus those for the CSI|H_{k,n}| can be expected to be similar. However, a per-subband auction as described herein is not necessarily required to feedback QSI and LM. For the signaling from BS 102 to MS or user, the per-stage auction as described herein can employ 1 bit per subband for s_{k,n}*, according to a non-limiting aspect. However, brute-force (CSI,QSI)-feedback schemes can require substantially more bits per subband for a relatively accurate p_{k,n}* to ensure acceptable performance. Therefore, compared with the brute-force (CSI,QSI)-feedback schemes for uplink OFDMA systems (e.g., uplink OFDMA systems 100, etc.), a scalarized per-subband auction can advantageously reduce signaling overhead and computation complexity (at the BS 102) for subband allocation and power allocation in a decentralized solution.

According to further non-limiting implementations, an online per-user primal-dual learning algorithm via stochastic approximation can be employed, as described above, to estimate {q^{k}(Q,|H|,s)} and LMs. For instance, the update equations for LMs can be the same as Eqns. 21 and 22, and thus, the online learning of per-user per-subband Q-factor {q^{k}(Q,|H|,s)} can be described as follows, according to various non-limiting aspects. For notation convenience, the per-user per-subband state-action pair can be denoted as φ [symbol] (Q,|H|,s). Let i (1≦i≦I_{φ}) be a dummy index enumerating over all the possible state-action pairs of each user over one subband with cardinality I_{φ}=2N_{H}(N_{Q}+1) and φ_{k,n}(t) [symbol] (Qₖ(t),|H_{k,n}(t)|,s_{k,n}(t)) be the current state-action pair observed at MS k on subband n at the t-th slot. Based on the current observation φ_{k,n}(t), user k 122 can update its estimate on the per-user per-subband Q-factor according to:

qₜ₊₁^{k}(φⁱ)=qₜ^{k}(φⁱ)+εₗ_{ₖ}_{(φ}_{ⁱ}_{,t)}^{q}[g_{k,n}_{ᵢ}_{^{k}}(γₜ^{k},φⁱ,p_{k,n}_{ᵢ}_{^{k}}(t))+\tilde{w}ₜ^{k}(Qₖ(t+1)))−(g_{k, n̅}_{_{I}}_{^{k}}(γₜ^{k},φ^{I},p_{k, n̅}_{_{I}}_{^{k}}( t̅))+\tilde{w}ₜ^{k}(Qₖ( t̅+1))−(qₜ^{k}(φ^{I}))−qₜ^{k}(φⁱ)]1[∪ₙ{φ_{k,n}(t)=φⁱ}] (43)

where

$${l}_{k} ( {φ}^{i} , t ) {=}^{Δ} {\sum }_{m = 0}^{t} 1 [ {⋃}_{n} \{ {φ}_{k , n} ( m ) = {φ}^{i} \} ]$$

can denote the number of updates of q^{k}(φⁱ) until t, nᵢ^{k}ε{n:φ_{k,n}(t)=φⁱ}, t̅ [symbol] sup{t:φ_{k n}(t)=φ^{I}}, φ^{I} is the reference (per-subband) state-action combination (per-user per-subband). Note that ∀nᵢ^{k}ε{n:φ_{k,n}(t)=φⁱ}, g_{k,n}_{ᵢ}_{^{k}}(γₜ^{k},φⁱ,p_{k,n}_{ᵢ}_{^{k}}(t)) can be expected to be equal. Note further that the reference (per-user) state-action combination φ^{r} can be composed of the (per-subband) state-action combination φ^{I}. For example, say N_{F}=2, Q={0,1}, |H|={Good (G), Bad (B)}, s={0, 1}, I_{φ},=2×2²×2²=48, I_{φ}=2×2×2=8. Let φ^{I}=(0,B,0), then φ^{r}=(0,{B,B},{0,0}) (aggregated over two subbands). Without loss of generality, the per-user per-subband Q-factor as can be initialized as 0, e.g., q₀^{k}(φ^{I})=0∀k. n̅_{I}^{k}ε{n:φ_{k,n}( t̅)=φ^{I}}

For the rate of convergence and asymptotic performance it should be noted how the convergence speed scales with the number of MS or users K 104 and the number of subbands N 106. For instance, in the asynchronous per-user per-subband Q-factor learning algorithm, at slot t, each user k 122 can update the Q-factor of all the per-user per-subband state-action pairs observed in N subbands 106. Thus, the convergence speed of the asynchronous per-user per-subband Q-factor learning algorithm can depend on the speed that every per-user per-subband state-action pair of each user k is visited at the steady state. Thus, the ergodic visiting speed for each MS or user 104k 122 can be defined as

$${V}_{k} = {lim}_{t \to ∞} \frac{{min}_{i} {l}_{k} ( {φ}^{i} , t )}{t} ,$$

where

$${l}_{k} ( {φ}^{i} , t ) {=}^{Δ} {\sum }_{m = 0}^{t} 1 [ {⋃}_{n} \{ {φ}_{k , n} ( m ) = {φ}^{i} \} ]$$

can denote the number of updates of q^{k}(φⁱ) up to slot t. The following lemma summarizes various non-limiting aspects regarding the ergodic visiting speed.

Lemma 6, ergodic visiting speed with respect to K and N, the ergodic visiting speed for each MS or user 104 k 122 of the per-user per-subband Q-factor stochastic learning algorithm in Eqn. 43 can be given by Vₖ= [symbol] (N/K)(∀k).

As proof of Lemma 6, K can be fixed such that the growth can be considered of the ergodic visiting speed with respect to N. As N increases, the number of per-user per-subband state-action pair observations made at each time slot increases (this “parallelism” helps to speed up the convergence rate). Thus, the chance that all per-user per-subband state-action pair of each user is visited grows like [symbol] (N), and hence, the ergodic visiting speed of each user grows like [symbol] (N). Next, N can be fixed and consider the growth of the ergodic visiting speed with respect to K. Each subband can only be allocated to one user. Thus, the chance of the bottleneck state-action pair with s=1 for each user being visited decreases like [symbol] (K), and hence, the ergodic visiting speed of each user grows like [symbol] (1/K). Combining the above two cases, Lemma 6 can be shown.

It is noted that the convergence rate of the learning algorithm is related to Vₖ= [symbol] (N/K). Observe that the convergence speed increases as N increases. This is because in the asynchronous update process in Eqn. 43, each user k updates the Q-factor of all the per-user per-subband state-action pair observed in N subbands in a single time slot. Thus, it can be understood that there can advantageously be intrinsic parallelism in the learning process across different subbands.

In addition, for various non-limiting implementations, it can be shown that the performance of the distributed algorithm is asymptotically global optimal for large number of users.

Theorem 2, asymptotically global optimal, for sufficiently large K 104 such that the optimization Problem 1 can be feasible, the performance of the online distributed per-user primal-dual learning algorithm can be expected to be asymptotically global optimal, e.g.,

$${\sum }_{k = 1}^{K} {∞}_{k}^{} ( {χ}_{k} , {s}_{k} ) \to {*}^{} ( χ , s )$$

and γ_{∞}→γ* as K→∞, where [symbol] *(χ,s) and γ* can denote the solution of the centralized Bellman equation in Eqn. 13 satisfying the corresponding constraints in Eqns. 9 and 10.

As proof of theorem 2, for given γ, it can be proven that under a Best-CSI subband allocation policy, the Q-factor satisfying the Bellman equation in Eqn. 13 can be decomposed into the additive form in Eqn. 15. Based on that, it can be shown that for large K, the linear Q-factor approximation in Eqn. 16 can indeed be optimal.

Definition 2, best-CSI subband allocation policy, a best-CSI subband allocation policy can be defined as

$${\tilde{Ω}}_{s} ( H ) = \{ {\tilde{s}}_{k , n} ( {H}_{n} ) ∈ \{ 0 , 1 \} \vert {\sum }_{k = 1}^{K} {\tilde{s}}_{k , n} = 1 ∀ n \} ,$$

where

\tilde{s}_{k,n}(Hₙ)=1[|H_{k,n}|=maxⱼ|H_{j,n|]=}1[|H_{k,n}|≧max_{j≠k}|H_{j,n}|] (44)

A property can first be established of the Q-factor in the original Bellman equation in Eqn. 13 under the Best-CSI subband allocation policy, which can be summarized in Lemma 7.

Lemma 7, additive property of the subband allocation Q-factor, under a Best-CSI subband allocation policy, the solution to the original Bellman equation in Eqn. 13 can be expressed into the form

$$( χ , s ) = {\sum }_{k} {∞}_{k}^{} ( {χ}_{k} , {s}_{k} ) ,$$

where { [symbol] _{∞}^{k}(χₖ,sₖ)} can denote the converged per-user Q-factor, which can also be the solution of the k-th user's per-user subband allocation Q-factor fixed point equation given by Eqn. 17.

Under the Best-CSI subband allocation policy, the Bellman equation in Eqn. 13 becomes

$$\begin{matrix} ( {χ}^{i} , s ) {=}^{( a )} {min}_{{Ω}_{p} ( {χ}^{i} )} [ g ( γ , {χ}^{i} , s , {Ω}_{p} ( {χ}^{i} ) ) + {\sum }_{{Q}^{j}} Pr [ {Q}^{j} \vert {χ}^{i} , s , {Ω}_{p} ( {χ}^{i} ) ] \underbrace{( {\sum }_{{H}^{j}} Pr [ {H}^{j} ] ( {χ}^{j} , {\tilde{Ω}}_{s} ( {H}^{j} ) ) )}_{\tilde{V} ( {Q}^{j} )} ] - θ \\ ∀ 1 \leq i \leq {I}_{χ} , ∀ s & ( 45 ) \\ {⇔}^{( b )} \tilde{V} ( {Q}^{i} ) = {\sum }_{{H}^{i}} Pr [ {H}^{i} ] {min}_{{Ω}_{p} ( {χ}^{i} )} [ g ( γ , {χ}^{i} , {\tilde{Ω}}_{s} ( {H}^{i} ) , {Ω}_{p} ( {χ}^{i} ) ) + {\sum }_{{Q}^{j}} Pr [ {Q}^{j} \vert {χ}^{i} , {\tilde{Ω}}_{s} ( {H}^{i} ) , {Ω}_{p} ( {χ}^{i} ) ] \tilde{V} ( {Q}^{j} ) ] - θ , \\ 1 \leq i \leq {I}_{Q} & ( 46 )\end{matrix}$$

where (a) is due to Eqn. 7 and the definition \tilde{V}(Q) [symbol] [symbol] [symbol] (χ,\tilde{Ω}ₛ(H))|Q], (b) can be obtained by taking conditional expectation (conditioned on Qⁱ) on both sides of Eqn. 45 and the definition of \tilde{V}(Q). In addition, denote

Δₖ\tilde{V}(Q) [symbol] [symbol] [\tilde{V}(Q+A)−\tilde{V}(Q+A−eₖ)|Q].

From Eqn. 45, it can be shown that { [symbol] (χⁱ,s)} can be determined by {\tilde{V}(Qⁱ)}. Next, solving {\tilde{V}(Qⁱ)} by the I_{Q} equations in Eqn. 46, first, assume the linear approximation

$$( χ , {\tilde{Ω}}_{s} ( H ) ) = {\sum }_{k} {k}^{} ( {χ}_{k} , {\tilde{Ω}}_{s}^{k} ( H ) )$$

holds under the best-CSI subband allocation policy, it follows that

$$\begin{matrix}\tilde{V} ( Q ) = 𝔼 [ {\sum }_{k} {k}^{} ( {χ}_{k} , {\tilde{Ω}}_{s}^{k} ( H ) ) \vert Q ] \\ = {\sum }_{k} 𝔼 [ {k}^{} ( {Q}_{k} , {H}_{k} , {\tilde{Ω}}_{s}^{k} ( H ) ) \vert Q ] \\ = {\sum }_{k} 𝔼 [ {k}^{} ( {Q}_{k} , {H}_{k} , {\tilde{Ω}}_{s}^{k} ( H ) ) \vert {Q}_{k} ] \\ = {\sum }_{k} 𝔼 [ 𝔼 [ {k}^{} ( {Q}_{k} , {H}_{k} , \{ {\tilde{s}}_{k , n} = 1 [ \vert {H}_{k , n} \vert \geq {max}_{j \neq k} \vert {H}_{j , n} \vert ] \} ) \\ \vert {Q}_{k} , {H}_{k} ] \vert {Q}_{k} ] = {\sum }_{k} 𝔼 [ {W}^{k} ( {χ}_{k} ) \vert {Q}_{k} ] \\ = {\sum }_{k} {\tilde{W}}^{k} ( {Q}_{k} )\end{matrix}$$

$${Δ}_{k} \tilde{V} ( Q ) = 𝔼 [ {\sum }_{j} {\tilde{W}}^{j} ( {Q}_{j} + {A}_{j} ) - ( {\sum }_{j \neq k} {\tilde{W}}^{j} ( {Q}_{j} + {A}_{j} ) + {\tilde{W}}^{k} ( {Q}_{k} + {A}_{k} - 1 ) ) \vert Q ] = Δ {\tilde{W}}^{k} ( {Q}_{k} )$$

Thus, the optimal power allocation and corresponding conditional departure rate to min_{Ω}_{ₚ}_{(χ}_{ⁱ}₎[.] part in Eqn. 46 are as follows

$$\begin{matrix}{p}_{k , n} ( {Q}_{k} , \vert {H}_{k , n} \vert , {\tilde{s}}_{k , n} ( {H}_{n} ) ) , ∀ k , n = {\tilde{s}}_{k , n} ( {H}_{n} ) {( \frac{\frac{τ}{{\overline{N}}_{k}} Δ {\tilde{W}}^{k} ( {Q}_{k} )}{{\overline{γ}}^{k}} - \frac{1}{{\vert {H}_{k , n} \vert}^{2}} )}^{+} & ( 47 ) \\ {μ}_{k} ( {Q}_{k} , {H}_{k} , {\tilde{s}}_{k} ( H ) ) , ∀ k = \frac{1}{\overline{{N}_{k}}} {\sum }_{n} {\tilde{s}}_{k , n} ( {H}_{n} ) log ( 1 + {p}_{k , n} ( {Q}_{k} , \vert {H}_{k , n} \vert , {\tilde{s}}_{k , n} ( {H}_{n} ) ) {\vert {H}_{k , n} \vert}^{2} ) & ( 48 )\end{matrix}$$

Therefore, from Eqn. 46, it follows that

$$\begin{matrix}{\sum }_{k} {\tilde{W}}^{k} ( {Q}_{k}^{i} ) = {\sum }_{k} ( \begin{matrix}{\tilde{g}}_{k} ( {γ}^{k} , {Q}_{k}^{i} ) + 𝔼 [ {\tilde{W}}^{k} ( {Q}_{k}^{i} + {A}_{k} ) \vert {Q}_{k}^{i} ] - \\ {\tilde{μ}}_{k} ( {Q}_{k}^{i} ) τ Δ {\tilde{W}}^{k} ( {Q}_{k}^{i} )\end{matrix} ) - θ ⇒ θ \\ = {\sum }_{k} {θ}^{k} = {\sum }_{k} ( \begin{matrix}{\tilde{g}}_{k} ( {γ}^{k} , {Q}_{k}^{i} ) + 𝔼 [ {\tilde{W}}^{k} ( {Q}_{k}^{i} + {A}_{k} ) \vert {Q}_{k}^{i} ] - \\ {\tilde{μ}}_{k} ( {Q}_{k}^{i} ) τ Δ {\tilde{W}}^{k} ( {Q}_{k}^{i} ) - {\tilde{W}}^{k} ( {Q}_{k}^{i} )\end{matrix} ) , \\ 1 \leq i \leq {I}_{Q}\end{matrix} \qquad ( 49 )$$

\tilde{g}ₖ(γ^{k},Qₖⁱ)

where

$$= 𝔼 [ \begin{matrix}{β}_{k} f ( {Q}_{k} ) + {\overline{γ}}^{k} ( {\sum }_{n} {p}_{k , n} ( {Q}_{k} , \vert {H}_{k , n} \vert , {\tilde{s}}_{k , n} ( {H}_{n} ) ) - {P}_{k} ) + \\ {\underline{γ}}^{k} ( 1 [ {Q}_{k}^{i} and = {N}_{Q} ] - {P}_{k}^{d} ) \vert {Q}_{k}\end{matrix} ]$$

\tilde{μ}ₖ(Qₖ)= [symbol] [μₖ(Qₖ,Hₖ,\tilde{s}ₖ(H))|Qₖ]. Since there can be (N_{Q}+1) QSI states for each user and the structure in Eqn. 49 can be decoupled under the additive assumption, for each user k, there are only (N_{Q}+1) independent Poisson equations with N_{Q}+2 unknowns {θ^{k},\tilde{W}^{k}(Qₖ)}. θₖ can be unique and {\tilde{W}^{k}(Qₖ)} can be unique up to an additive constant. Therefore, {θ,\tilde{V}(Q)} can be the solution to Eqn. 46, where

$$θ = {\sum }_{k} {θ}^{k}$$

and

$$Q ( χ , s ) = {\sum }_{k} {Q}_{∞}^{k} ( {χ}_{k} , {s}_{k} ) .$$

Next, it can be shown that

$$\tilde{V} ( Q ) = {\sum }_{k} {\tilde{W}}^{k} ( {Q}_{k} ) .$$

### Substituting

$$θ = {\sum }_{k} {θ}^{k}$$

and

$$\tilde{V} ( Q ) = {\sum }_{k} {\tilde{W}}^{k} ( {Q}_{k} )$$

into Eqn. 45, it follows that

$$\begin{matrix}Q ( {χ}^{i} , s ) = {min}_{{Ω}_{p} ( {χ}^{i} )} [ \begin{matrix}g ( γ , {χ}^{i} , s , {Ω}_{p} ( {χ}^{i} ) ) + \\ {\sum }_{{Q}^{j}} Pr [ {Q}^{j} \vert {χ}^{i} , s , {Ω}_{p} ( {χ}^{i} ) ] ( {\sum }_{k} {\tilde{W}}^{k} ( {Q}_{k}^{j} ) )\end{matrix} ] - \\ {\sum }_{k} {θ}^{k} \\ = {\sum }_{k} {Q}^{k} ( {χ}_{k}^{i} , {s}_{k} )\end{matrix}$$

where

$${Q}^{k} ( {χ}_{k}^{i} , {s}_{k} ) = {min}_{{p}_{k}} [ {g}_{k} ( {γ}^{k} , {χ}_{k}^{i} , {s}_{k} , {p}_{k} ) + {\sum }_{{Q}_{k}^{j}} Pr [ {Q}_{k}^{j} \vert {χ}_{k}^{i} , {s}_{k} , {p}_{k} ] {\tilde{W}}^{k} ( {Q}_{k}^{j} ) ] - {θ}^{k} ,$$

which can be equivalent to Eqn. 17. By Lemma 2, the converged { [symbol] _{∞}^{k}(χₖ,sₖ)} can satisfy Eqn. 16, which can complete the proof

Next, the asymptotic subband allocation results for large K can be considered. The optimal control actions to Eqn. 13 are given by

$$\begin{matrix}{p}_{k , n} ( {H}_{n} , Q ) = {s}_{k , n} ( {H}_{n} , Q ) {( \frac{\frac{τ}{{\overline{N}}_{k}} {Δ}_{k} {\tilde{V}}^{*} ( Q )}{{\overline{γ}}^{k}} - \frac{1}{{\vert {H}_{k , n} \vert}^{2}} )}^{+} & ( 50 ) \\ {s}_{k , n} ( {H}_{n} , Q ) = \{ \begin{matrix}1 , & if {X}_{k , n} = {max}_{j} \{ {X}_{j , n} \} > 0 \\ 0 , & otherwise\end{matrix} & ( 51 )\end{matrix}$$

where \tilde{V}*(Q) [symbol] [symbol] [minₛ [symbol] *(χ,s)|Q], Δₖ\tilde{V}*(Q) [symbol] [symbol] [\tilde{V}*(Q+A)−[\tilde{V}*(Q+A−eₖ)|Q]and

$${X}_{k , n} = \frac{τ}{{N}_{k}} {Δ}_{k} {\tilde{V}}^{*} ( Q ) log ( 1 + {\vert {H}_{k , n} \vert}^{2} {( \frac{\frac{τ}{{\overline{N}}_{k}} {Δ}_{k} {\tilde{V}}^{*} ( Q )}{{\overline{γ}}^{k}} - \frac{1}{{\vert {H}_{k , n} \vert}^{2}} )}^{+} ) .$$

$$- {{\overline{γ}}^{k} ( \frac{\frac{τ}{{\overline{N}}_{k }} {Δ}_{k} {\tilde{V}}^{*} ( Q )}{{\overline{γ}}^{k}} - \frac{1}{{\vert {H}_{k , n} \vert}^{2 }} )}^{+}$$

Denote kₙ* [symbol] arg maxₖ|H_{k,n}|². For large K, |H_{k,n}|² grows with log(K) by extreme value theory. Because the traffic loading remains unchanged as it is scale up K, max_{k,j}|Δₖ\tilde{V}*(Q)−Δⱼ\tilde{V}*(Q)|=O(1). Hence, X_{k*}_{ₙ}_{,n} grows like log(log(K)). As K→∞, Pr[kₙ*=arg maxₖX_{k,n}]=1. Thus the subband allocation result of optimal subband allocation in Eqn. 51 and the best CSI subband allocation in Eqn. 44 will be the same for large K. Using the result in Lemma 7, the linear Q-factor approximation is therefore asymptotically accurate for given γ. Combining with the results of theorem 1, theorem 2 can be proven.

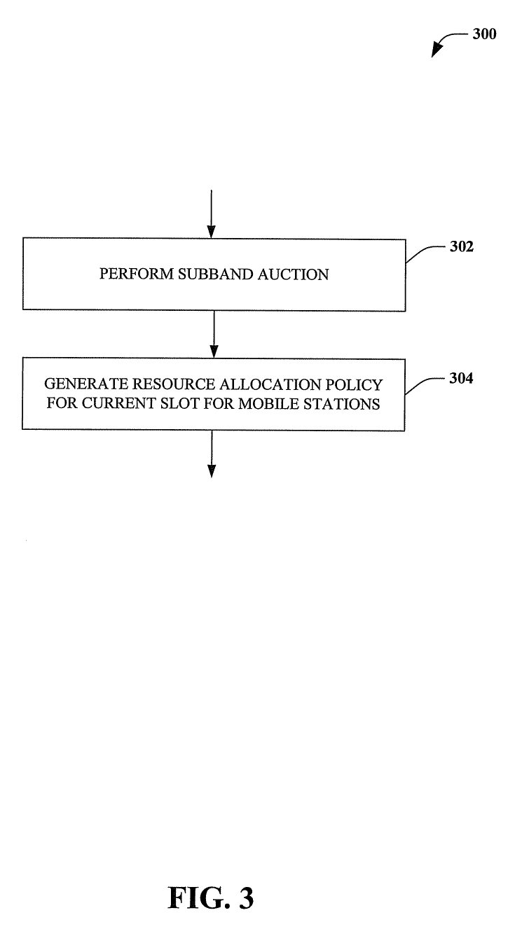

In view of the exemplary embodiments described supra, methods that can be implemented in accordance with the disclosed subject matter will be better appreciated with reference to the flowcharts of FIGS. 3-5. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods disclosed hereinafter and throughout this specification are capable of being stored on an article of manufacture to facilitate transporting and transferring such methods to computers, for example, as further described herein. The term article of manufacture, as used herein, is intended to encompass a computer program accessible from any computer-readable device and/or media.

### Exemplary Methods

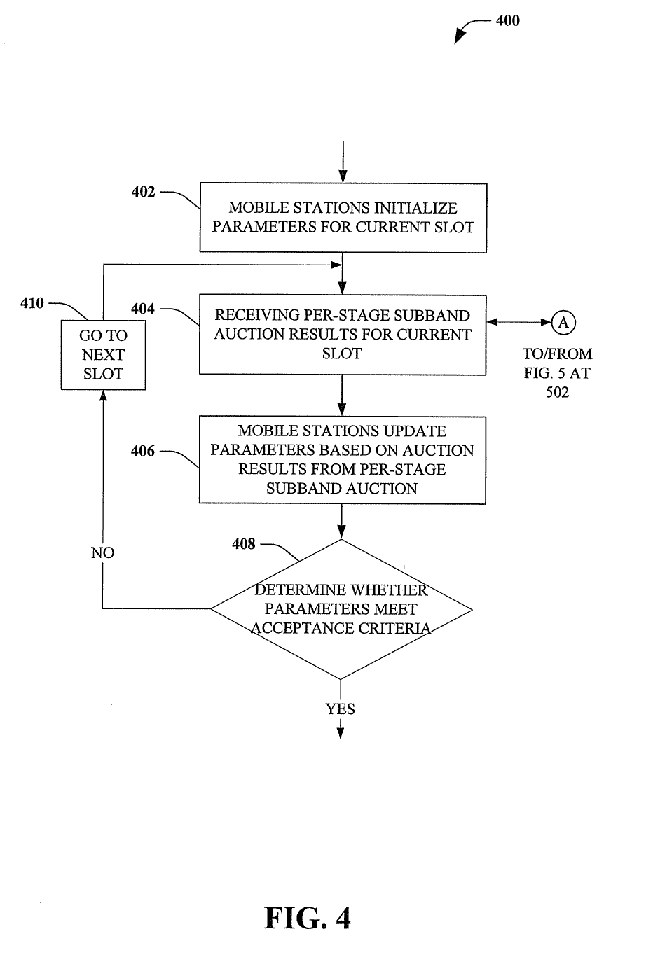

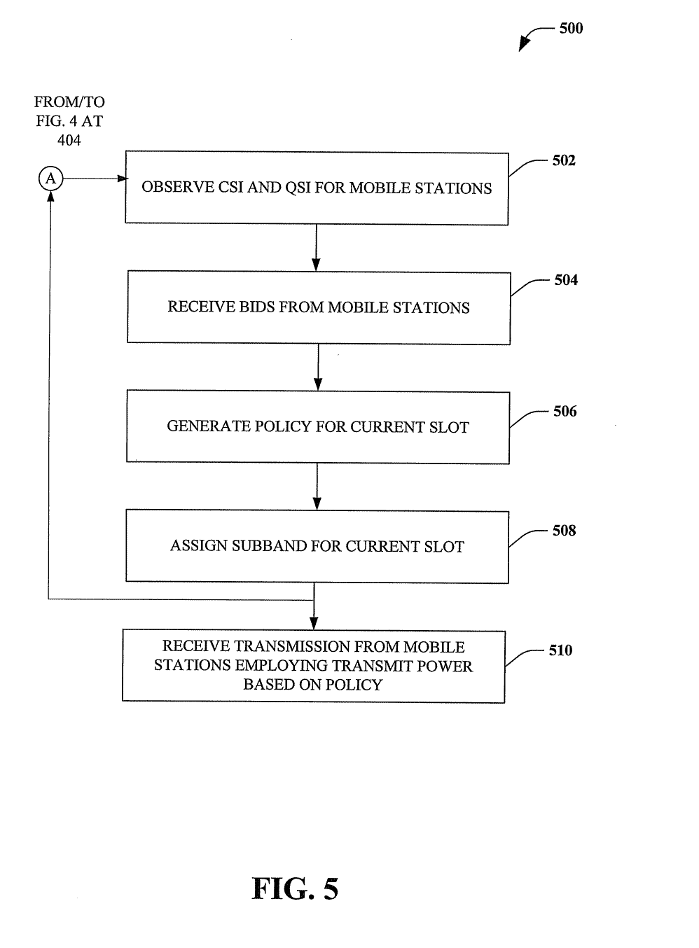

FIG. 3 depicts a flowchart of exemplary methods 300 for power and subband allocation, according to particular aspects of the subject disclosure. For instance, at 302 a per-stage subband auction can be performed to facilitate performing subband and/or power allocation for one or more mobile station(s) 104 as further described below regarding FIGS. 4-5. In addition, at 304, methods 300 can further include generating a resource allocation policy for a current slot for mobile stations as further described below regarding FIGS. 4-5. Moreover, methods 300 can further include updating potential functions and Lagrange multipliers as described herein.

FIGS. 4-5 depict non-limiting flowchart of an exemplary algorithm for online distributed primal-dual value iteration algorithm with per-stage auction and simultaneous updates on potential and Lagrange multipliers, according to various non-limiting implementations of the disclosed subject matter. For instance, according to particular non-limiting aspects, FIG. 4, depicts an exemplary flowchart of methods 400 for resource allocation in a wireless communication system (e.g., system 100, 200, etc.). As a non-limiting example, methods 400 can include initializing a set of parameters of one or more mobile stations 104 (e.g., one or more users, mobile users, mobile devices, mobile stations, etc.) at 402 for a current slot. For instance, as a non-limiting illustration, initializing a set of parameters of one or more mobile stations 104 can include setting slot index t=0, and each mobile station 104 or user k=1:K can choose an initial potential per-user per-subband allocation Q-factor, q₀^{k}, and Lagrange multiplier (LM), γ₀^{k}. In addition, methods 400 can comprise providing, from a mobile device 104 (e.g., one or more users, mobile users, mobile devices, mobile stations, etc.) CSI and QSI associated with the mobile device to a resource allocation controller or a resource allocation controller component 116 and transmitting a bid for resource allocation from the mobile device to the resource allocation controller. At 404, methods 400 can include receiving per-stage subband auction results such as for a resource allocation policy, as further described below regarding FIG. 5. Thus, methods 400 can comprise receiving a subband allocation result from the resource allocation controller or resource allocation controller component 116 at 404.

At 406, methods 400 can include updating the set of parameters of the one or more mobile stations 104 based on auction results from the per-stage subband auction. For instance, as describe herein regarding online policy improvement, at the beginning of the t-th slot, BS 102 can perform the per-stage subband auction to obtain policy Ωₜ=(Ωₚ,Ωₛ) for the t-th slot. In a further example regarding online potential and LM updating as described herein, at the end of the t-th slot, each mobile station 104 or user k=1:K can update the potential per-user per-subband subband allocation Q-factor, qₜ₊₁^{k} according to Eqn. 25 and can update the Lagrange multiplier γₜ₊₁^{k} according to Eqns. 26 and 31 for the t+1-th slot. In addition, methods 400 can further include determining a transmit power based on the subband allocation result, as further described herein.

Thus, at 408 it can be determined whether the set of parameters meet acceptance criteria, For example, according to a non-limiting aspect as further described above, a policy Ω can be called feasible if the associated actions (e.g., subband and power allocation) can satisfy an average total transmit power constraint and a subband assignment constraint (e.g., satisfies the power and packet drop rate constraints in Eqns. 9 and 10). In a further non-limiting example, as described below regarding FIG. 5, it can be determined whether the average power constraint and the packet drop constraint are satisfied for the resource allocation policy resulting from the per-stage subband auction. In yet another non-limiting example, as described herein, various non-limiting implementations can determine whether parameters meet acceptance criteria, for example, |\hat{q}ₜ₊₁^{k}−\hat{q}ₜ^{k}∥<δ_{q}∀k and ∥γₜ₊₁^{k}−γₜ^{k}∥<δ_{γ}∀k . If it is determined at 508 that the set of parameters do not meet acceptance criteria, then the methods 400 can proceed by advancing to the next slot at 410 (e.g., increment slot index, t=t+1) and the per-stage subband auction can be repeated as described below regarding FIG. 5.

FIG. 5 depicts an exemplary flowchart of methods 500 for resource allocation in a wireless communication system (e.g., system 100, 200, etc.). For instance, at 502, methods 500 for resource allocation can comprise observing joint channel state information (CSI) and joint queue state information (QSI) associated with one or more mobile stations 104 (e.g., one or more users, mobile users, mobile devices, mobile stations, etc.). As an example, local QSI and CSI, [symbol] ₖ and H_{k,n}, qₜ^{k}, and γₜ^{k} can be input to determine system state χₖ at each MS 104 for user k=1:K. As a further non-limiting example, each mobile station 104 can observe its local CSI and QSI for submission. In addition, methods 500 can include approximating joint QSI as a function of a set of the local QSI associated with individual mobile stations of one or more mobile stations 104, as described above. As a non-limiting example, as further described above, the subband allocation Q-factor can be approximated by the sum of the per-user subband allocation Q-factor. In a further non-limiting example, approximating the joint QSI can include simultaneously updating Lagrange multipliers, based on an average power constraint and a packet drop constraint, and at least one of the set of local QSI associated with individual mobile stations.

In addition, at 504, methods 500 for resource allocation can also comprise receiving bids for resource allocation from one or more mobile stations. As a non-limiting example, methods 500 can include receiving bids for resource allocation (e.g., subband allocation according to a subband allocation policy, etc.) from one or more mobile stations 104 (e.g., users, mobile users, mobile devices, mobile stations, etc.). For instance, as further described herein, each mobile station 104 can submit one or more bid(s) to the base station. As a further non-limiting example, based on the local observation χₖ, each user k 122 can submit a bid { [symbol] ^{k}(χₖ,sₖ):∀sₖ} to BS 102.

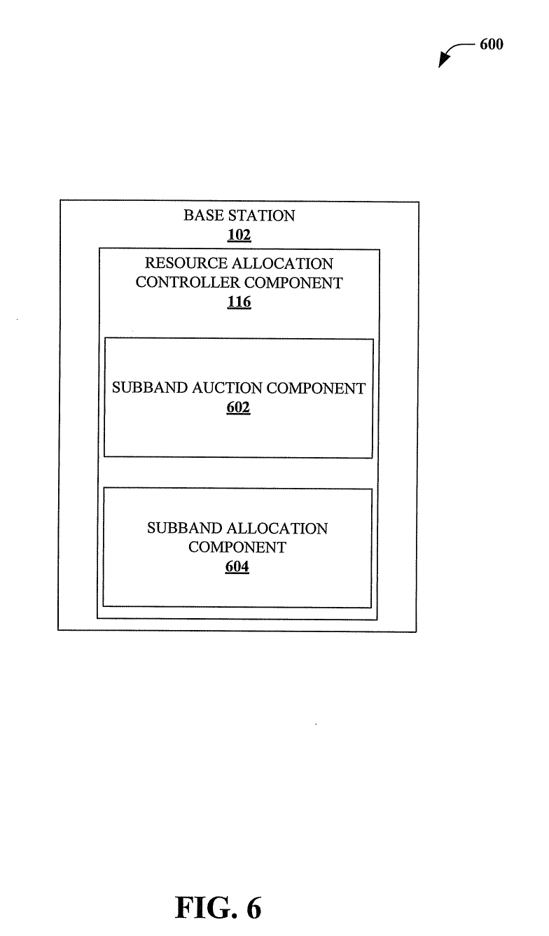

In addition, methods 500 can include generating (e.g., a generating via a processor, and so on, as further described herein regarding, FIGS. 6-8, 14-16, etc.) resource allocation policy at 506, based on the bids and a per-stage subband auction mechanism, for a current schedule slot of a plurality of schedule slots. As a non-limiting example, the base station can assigns subbands, for instance, based on submitted bids, as further described below. For instance, as described above, in still further non-limiting aspects, according to an online per-user primal-dual learning algorithm via a stochastic approximation, because the derived power and subband allocation policies represent functions of the per-user subband allocation Q-factor and LMs, an online localized learning algorithm can estimate { [symbol] ^{k}(χₖ,sₖ)} and LMs γ^{k} at each MS k 122. As a further non-limiting example, generating the resource allocation policy can include determining the resource allocation policy based on observing joint channel state information and joint queue state information (QSI) associated with the plurality of mobile stations. For instance, determining the resource allocation policy can include determining a subband allocation policy including subband allocation results as described below and a transmit power policy for the mobile stations 104.

Moreover, at 508, methods 500 can further include assigning a subband, based on the resource allocation policy, to one or more mobile stations 104 for the current slot. In a non-limiting example, methods 500 can further include broadcasting subband allocation results of the auction mechanism to the plurality of mobile stations. For instance, as described above regarding subband allocation, BS 102 can assign the n-th subband according to the highest bid as per Eqn. 24 and can then broadcasts the allocation results to K users 104, where s_{k,n}, p_{k,n} can denote subband and power allocation action, respectively, for user k=1:K. As a result, each mobile station 104 can receive the subband allocation results and can perform power allocation, as further described herein.

Thus, at 510, methods 500 can include receiving a transmission from one or more mobile stations 104 that can employ a transmit power determined by the one or more mobile stations based on the subband allocation results. As a further non-limiting example, as described above, regarding power allocation, each user or mobile station 104 can determine transmit power p_{k,n} according to Eqn. 25 for user k=1:K. Thus, as describe above regarding FIG. 4 methods 500 can further comprise determining whether parameters of the wireless communication system meet an acceptance criteria. In yet another non-limiting example, methods 500 can include determining whether the average power constraint and the packet drop constraint are satisfied for the resource allocation policy.

In view of the methods described supra, systems and devices that can be implemented in accordance with the disclosed subject matter will be better appreciated with reference to the functional block diagrams of FIGS. 6-8. While, for purposes of simplicity of explanation, the functional block diagrams are shown and described as various assemblages of functional component blocks, it is to be understood and appreciated that such illustrations or corresponding descriptions are not limited by such functional block diagrams, as some implementations may occur in different configurations. Moreover, not all illustrated blocks may be required to implement the systems and devices described hereinafter.

### Exemplary Systems and Apparatuses

FIG. 6 depicts a non-limiting block diagram of systems 600 for wireless communication resource allocation, according to various non-limiting aspects of the disclosed subject matter. As a non-limiting example, systems 600 can comprise an exemplary BS 102, as described herein. For instance, as described herein, BS 102 can be configured to employ distributed queue-aware power and subband allocation designs to achieve delay-optimal OFDMA uplink systems. In a further example, as described herein, BS 102 can employ distributed delay-optimal power and subband allocation designs and can implement control actions that are a function of instantaneous Channel State Information and joint Queue State Information. Thus, in various non-limiting implementations, BS 102, as described, can be employed in a variety of environments where it can communicate with various mobile stations 104 (e.g., one or more users, mobile users, mobile devices, mobile stations, etc.). In this regard, BS 102 can comprise, employ, or be associated with a cross-layer controller 116 (e.g., a resource allocation controller, a resource allocation controller component (RACC), etc), as described herein, which can be configured to utilize joint CSI 112 and joint QSI 114 as inputs and can produce power allocation 118 and subband allocation 120 actions or policies as outputs. Thus, BS 102 can be configured to receive local channel state information (CSI) and local queue state information (QSI) from one or more mobile stations 104.

In addition, as mentioned, BS 102 can comprise, employ, or be associated with a cross-layer controller 116 (e.g., a resource allocation controller, a resource allocation controller component (RACC), etc). Thus, in further non-limiting implementations of system 600, a resource allocation controller component 116 can be associated with the BS 102. In a non-limiting aspect, resource allocation controller component 116 can be configured to determine joint QSI as a function of the local QSI, as further described herein.

In addition, resource allocation controller component 116 can comprise, employ, or be associated with a subband auction component 602. For instance, systems 600 can comprise a subband auction component 602 associated with the resource allocation controller component 116. In a further non-limiting aspect, subband auction component 602 can be configured to perform a per-stage subband auction, based on the local CSI and the joint QSI. Moreover, in further non-limiting implementations, subband auction component 602 can be further configured to determine a resource allocation policy that can includes one or more of a power allocation policy and a subband allocation policy for the mobile stations 104. Additionally, in other non-limiting implementations, resource allocation controller component 116 can also be configured to determine whether an average power constraint or a packet drop constraint is satisfied for the resource allocation policy, as further described above, for example, regarding FIGS. 4-5.

In yet other non-limiting implementations, systems 600 can further comprise a subband allocation component 604. For example, systems 600 can further comprise a subband allocation component 604 associated with the resource allocation controller component 116. In an exemplary aspect, subband allocation component 604 can be configured to assign a subband to one or more mobile stations, according to subband allocation results of the per-stage subband auction, as further described herein (e.g., the per-stage subband auction assigns subbands based on bids for resource allocation from the plurality of mobile stations, etc.). In a further non-limiting example, subband allocation component 604 can be further configured to broadcast the subband allocation results to one or more mobile stations. Further discussion of the advantages and flexibility provided by the various non-limiting embodiments can be appreciated by review of the following description.

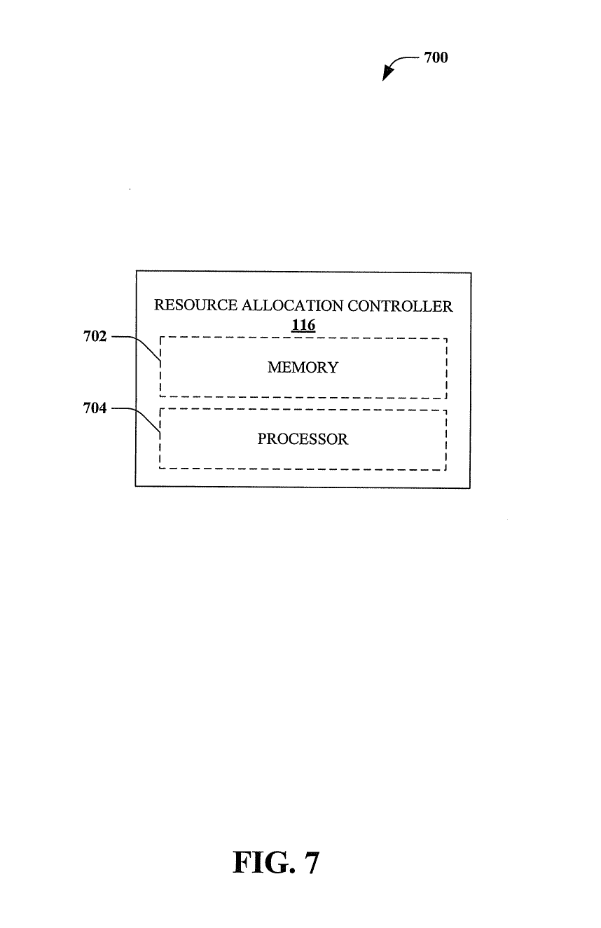

For example, FIG. 7 illustrates an exemplary non-limiting resource allocation controller 116 suitable for performing various techniques of the disclosed subject matter. The resource allocation controller 116 can be a stand-alone resource allocation controller or portion thereof or a specially programmed computing device or a portion thereof (e.g., a memory retaining instructions for performing the techniques as described herein coupled to a processor). Resource allocation controller 116 can include a memory 702 that retains various instructions with respect to observing system state, receiving bids, performing per-stage auctions, generating resource allocation policies, assigning subbands, testing performance criteria, statistical calculations, analytical routines, and/or the like. For instance, resource allocation controller 116 can include a memory 702 that retains instructions for receiving bids for resource allocation from one or more mobile stations. The memory 702 can further retain instructions for generating a resource allocation policy, based on the bids and a per-stage subband auction mechanism, for a current schedule slot. Additionally, memory 702 can retain instructions for assigning a subband, based on the resource allocation policy, to a mobile station of the one or more mobile stations.

Memory 702 can further include instructions pertaining to receiving a transmission from the mobile station employing a transmit power determined by the mobile station based on the subband allocation results; to approximating the joint QSI as a function of a set of local QSI associated with individual mobile stations of the one or more mobile stations; to determining whether the average power constraint and the packet drop constraint are satisfied for the resource allocation policy; to determining the resource allocation policy based on observing joint CSI and joint QSI associated with the one or more mobile stations; to determining a subband allocation policy including the subband allocation results and a transmit power policy for the one or more mobile stations; to simultaneously updating LM, based on an average power constraint and a packet drop constraint, and one of the set of local QSI associated with individual mobile stations; and/or to broadcasting subband allocation results of the per-stage subband auction mechanism to the one or more mobile stations. The above example instructions and other suitable instructions can be retained within memory 702, and a processor 704 can be utilized in connection with executing the instructions.

In further non-limiting implementations, resource allocation controller 116 can comprise processor 704, and/or computer readable instructions stored on a non-transitory computer readable storage medium (e.g., memory 702, a hard disk drive, and so on, etc.), the computer readable instructions, when executed by a computing device, e.g., processor 704, can cause the computing device perform operations, according to various aspects of the disclosed subject matter. For instance, as a non-limiting example, the computer readable instructions, when executed by a computing device, can cause the computing device generate a resource allocation policy, based on bids for resource allocation from one or more mobile stations and a per-stage subband auction mechanism for a current slot, assign a subband, based on the resource allocation policy, to a mobile station of the one or more mobile stations for the current slot, and so on, etc., as described herein.

Accordingly, in further non-limiting embodiments, the disclosed subject matter provides a computer readable storage medium (e.g., a hard disk drive, optical drive, a memory, a flash memory, and so on, etc.) comprising computer executable instructions that, in response to execution, cause a computing device to perform operations as described herein. For instance, computer executable instructions can cause a computing device, to perform operations such as, receiving bids for resource allocation from one or more mobile devices, generating a resource allocation policy for a current schedule slot of one or more schedule slots including auctioning subbands based on the bids, and assigning a subband, based on the resource allocation policy, to a mobile device of the one or more mobile devices for the current slot, as well as other operations as described above regarding FIGS. 1-6, etc., regarding a base station, resource allocation controller, and so on In addition, in still further non-limiting implementations, the disclosed subject matter provides a computer readable storage medium comprising computer executable instructions that, in response to execution, cause a computing device to perform operations particular to mobile devices 104 (e.g., mobile stations, mobile users, etc. of system 100, 200, 800, and so on) such as initializing parameters, sending CSI and QSI to a base station, a resource allocation controller, portions thereof, and so on, etc., receiving one or more of a subband allocation policy, a power allocation policy, and/or a subband assignment, uppdating parameters based on auction results from a per-stage subband auction as described herein, determining whether parameters meet acceptance criteria, and so on as further described herein.

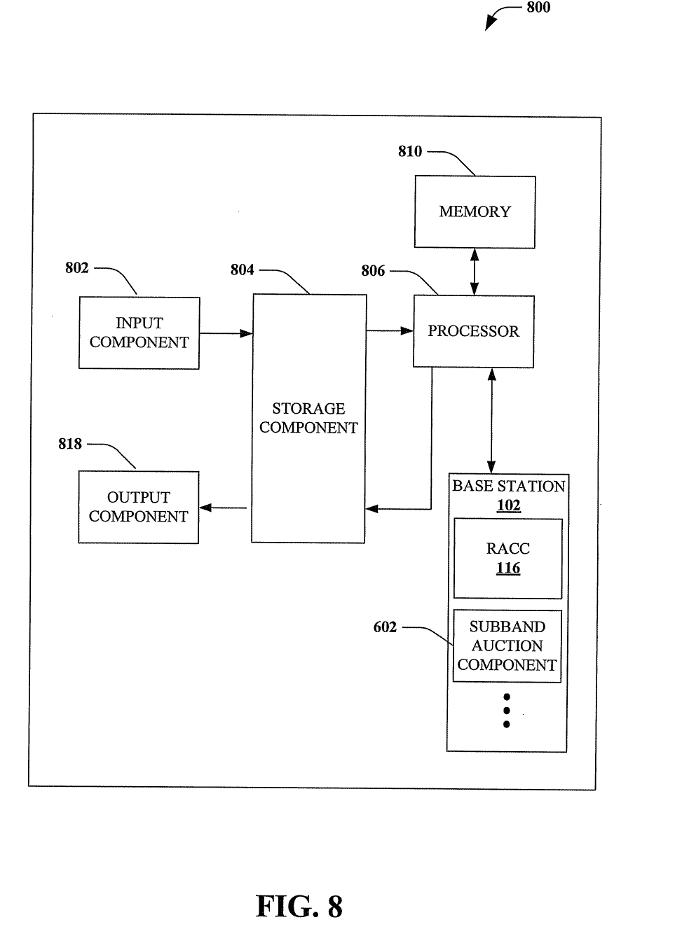

FIG. 8 illustrates systems or apparatuses 800 that can be utilized in connection with distributed queue-aware power and subband allocation design for a delay-optimal OFDMA uplink system as described herein. As a non-limiting example, systems or apparatuses 800 can comprise an input component 802 that can receive data, signals, information, feedback, and so on to facilitate subband and power allocation, and can perform typical actions thereon (e.g., transmits to storage component 804 or other components such as RACC 116, subband auction component 602, subband allocation component 604, portions thereof, and so on, etc.) for the received data, signals, information, feedback, etc. A storage component 804 can store the received data, signal, information (e.g., action, observation, policy, and/or intermediate results, such as described above regarding FIGS. 1-5, etc.) for later processing or can provide it to RACC 116, or a processor 806, via memory 810 over a suitable communications bus or otherwise, or to the output component 818.

Processor 806 can be a processor dedicated to analyzing information received by input component 802 and/or generating information for transmission by an output component 818. Processor 806 can be a processor that controls one or more portions of systems or apparatuses 800, and/or a processor that can analyze information received by input component 802, can generate information for transmission by output component 818, and can perform various power and subband allocation algorithms associated with RACC 116, or as further described herein. In addition, systems or apparatuses 800 can further include a RACC 116, as described above and that can perform various techniques as described herein, in addition to the various other functions required by other components as described above.

While RACC 116 is shown external to the processor 806 and memory 810, it is to be appreciated that RACC 116 can include code or instructions stored in storage component 804 and subsequently retained in memory 810 for execution by processor 806. In addition, RACC 116 can utilize artificial intelligence based methods in connection with performing inference and/or probabilistic determinations and/or statistical-based determinations in connection applying the power and subband allocation techniques described herein.

Systems or apparatuses 800 can additionally comprise memory 810 that is operatively coupled to processor 806 and that stores information such as described above, parameters, information, and the like, wherein such information can be employed in connection with implementing the power and subband allocation techniques as described herein. Memory 810 can additionally store protocols associated with generating lookup tables, etc., such that systems or apparatuses 800 can employ stored protocols and/or algorithms further to the performance of various algorithms and/or portions thereof as described herein.

It will be appreciated that storage component 804 and memory 806, or any combination thereof as described herein, can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), and direct Rambus RAM (DRRAM). The memory 810 is intended to comprise, without being limited to, these and any other suitable types of memory, including processor registers and the like. In addition, by way of illustration and not limitation, storage component 804 can include conventional storage media as in known in the art (e.g., hard disk drive).

Accordingly, in further non-limiting implementations, exemplary systems or apparatuses 800, such as a resource allocation controller 116 in a wireless communication system, can comprise means for performing a per-stage subband auction, on behalf of one or more mobile users, for a current schedule slot of one or more schedule slots. For instance, RACC 116 can comprise means for receiving bids for resource allocation from the one or more mobile users, as further described herein. Furthermore, RACC 116 can comprise a means for generating a resource allocation policy based the per-stage subband auction, for example, as described above regarding FIG. 1-7, 14-16, etc. For instance, the means for generating a resource allocation policy can include means for determining a subband allocation policy, including the subband allocation results, and a transmit power policy for the one or more mobile users, and so on, etc.

In addition, exemplary RACC 116 can further comprise means for assigning a subband, based on the resource allocation policy, to a mobile user of the one or more mobile users, for example, as described above regarding FIGS. 1-5, to facilitate subband and power allocation. For instance, the means for assigning a subband can include a means for broadcasting subband allocation results of the per-stage subband auction to the one or more mobile stations.

In further non-limiting embodiments of exemplary systems or apparatuses 800, RACC 116 can also include means for observing joint CSI and joint QSI associated with the one or more mobile users, and means for approximating the joint QSI as a function of a set of local QSI associated with individual mobile users of the one or more mobile users, as described above regarding FIGS. 1-5, etc. In addition, systems or apparatuses 800 comprising RACC 166 can also include means for determining whether an average power constraint and/or a packet drop constraint is satisfied for the resource allocation policy, as further described herein.

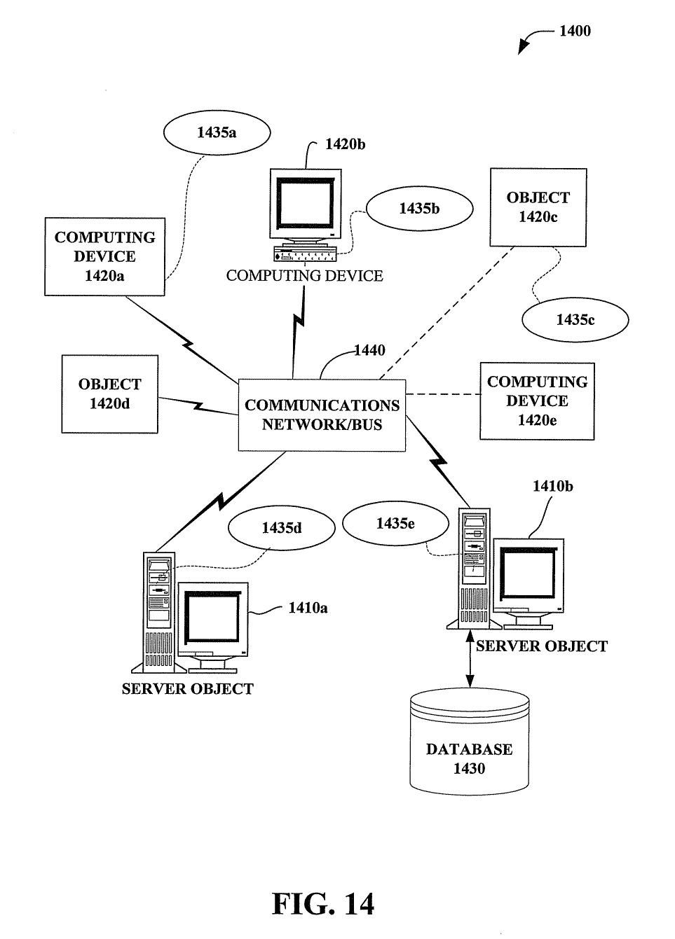

It can be understood that in various non-limiting implementations, various aspects of the disclosed subject matter can be performed by a mobile device 104 (e.g., one or more users, mobile users, mobile devices, mobile stations, etc.). That is, various non-limiting aspects of the disclosed subject matter can be performed by a mobile device 104 having portions of FIG. 8 (e.g., input component 802, storage component 804, processor 806, memory 810, output component 818, etc.) without base station 102, RACC 116, subband auction component 602, etc. Thus, in still other non-limiting implementations, exemplary systems or apparatuses 800, can also include a mobile device 104, as described above regarding FIG. 1-7, etc., for instance. As a non-limiting example, mobile device 104 can be configured to provide CSI and/or QSI associated with the mobile device 104 to a resource allocation controller 116, base station 102, etc. In addition, mobile device 104 can be configured to transmit a bid for resource allocation to the resource allocation controller 116 and to receive a subband assignment and a power allocation policy from the resource allocation controller, based on the CSI, QSI, and the bid. In a further non-limiting example, the mobile device 104 can be further configured to determine a transmit power based on the subband assignment and the power allocation policy, as further described herein. As can be understood, mobile device 104 can be further configured to perform various aspects as described herein, regarding FIGS. 1-7, as well as additional and/or ancillary aspects as further described below regarding FIGS. 14-16.

### Simulation Results

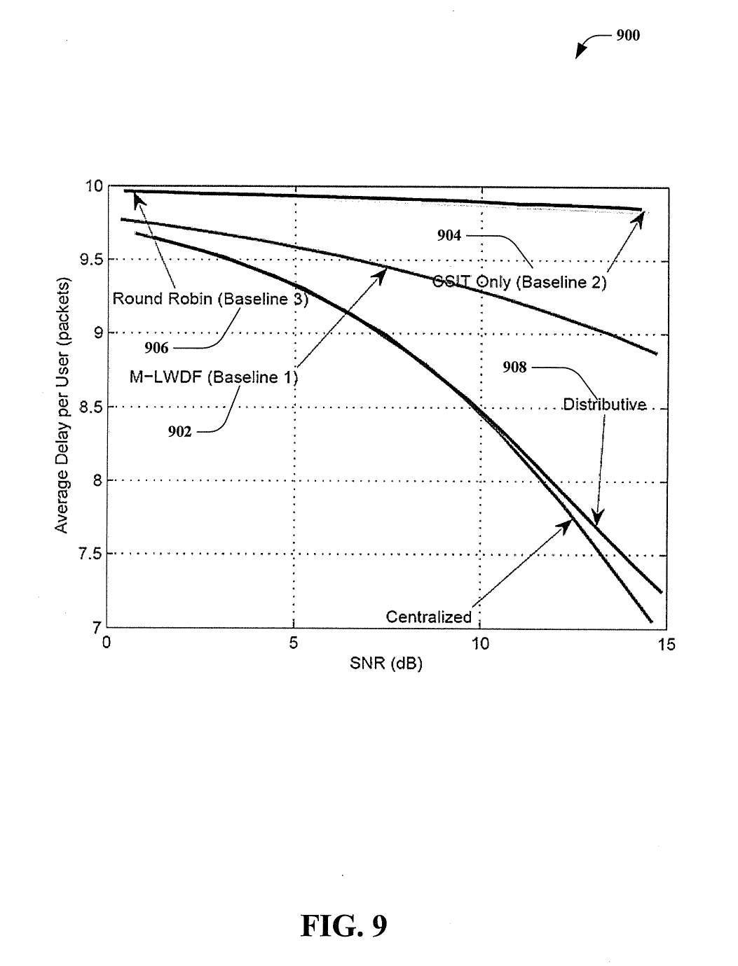

FIGS. 9-13 demonstrate exemplary performance of various non-limiting embodiments, in accordance with aspects of the disclosed subject matter. For instance, various non-limiting implementations of a per-user online learning algorithm via stochastic approximation to the delay optimal problem for OFDMA uplink systems (e.g., OFDMA uplink systems 100, etc.) with the centralized subband allocation Q-factor { [symbol] (χ,s)} learning algorithm as described herein can be compared to other reference baselines to demonstrate capabilities of various embodiments of the disclosed subject matter. For example, FIG. 9 depicts average delay per user versus SNR. For instance, baseline 1 902 refers to a throughput optimal policy, namely the Modified Largest Weighted Delay First (M-LWDF), in which the subband and power control can be chosen to maximize the weighted delay. For example, it is noted that a throughput optimal policy can mean that it shall stabilize the queue whenever the arrival rate vector falls within the stability region. Baseline 2 904 refers to CSIT only scheduling, in which optimal subband and power allocation can be performed purely based on CSIT. Baseline 3 906 refers to Round Robin Scheduling, in which different users can be served in time division multiple access (TDMA) fashion with equally allocated time slots and water-filling power allocation across the subbands.

Referring again to FIG. 9, the number of users K=2, the buffer size N_{Q}=10, the mean packet size N̅ₖ=305.2 Kilobyte/packet (Kbyte/pck), the average arrival rate λₖ=20 packet/second (pck/s), and the queue weight, β₁=β₂=1. It is noted that the packet drop rate of the non-limiting implementation of a distributed solution 908 as described herein is 5%, while the packet drop rate of the Baseline 1 (M-LWDF) 902, Baseline 2 (CSIT Only) and Baseline 3 (Round Robin) are 5%, 8%, 9% respectively. In the simulation, Poisson packet arrival with average arrival rate λₖ(pck/s) and exponential packet size distribution with mean N̅ₖ can be considered. Average delay can be considered as utility

$$( f ( {Q}_{k} ) = \frac{{Q}_{k}}{{λ}_{k}} ) .$$

In addition, it can be assumed that there are 64 subbands with total bandwidth (BW) of 10 MegaHertz (MHz), and the number of independent subbands N_{F} 106 can be 4. The scheduling slot duration τ is chosen as 5 ms, and the buffer size N_{Q} is chosen as 10.

Thus, FIG. 9 illustrates the average delay per user versus SNR of two users. It can be observed that both the centralized solution and the distributed solution have significant gain compared with the three baselines (e.g., more than 7.5 dB gain over M-LWDF 902 when average delay per queue is less than 9 packets). In addition, the delay performance of the non-limiting implementation of a distributed solution 908 as described herein (e.g., which is asymptotically global optimal in large number of users) can be seen to approximate the performance of the optimal solution even in K=2.

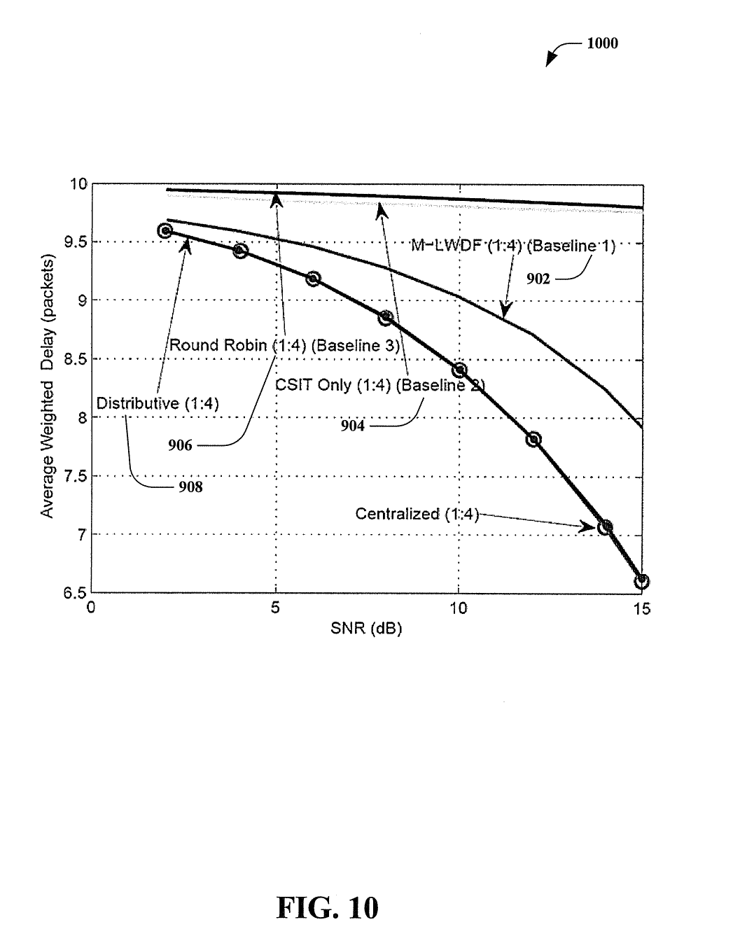

FIG. 10 depicts average weighted delay versus SNR, where the number of users K=2, the buffer size N_{Q}=10, the mean packet size N̅ₖ=305.2 Kbyte/pck, the average arrival rate λₖ=20 pck/s, and the queue weight β₁=1, β₂=4. It is noted that the packet drop rate of the non-limiting implementation of a distributed solution 908 as described herein is 7%, while the packet drop rate of the Baseline 1 902 (M-LWDF), Baseline 2 904 (CSIT Only), and Baseline 3 906 (Round Robin) are 7%, 9%, 9%, respectively. Similar observations as for FIG. 9 could be made regarding FIG. 10, where the average weighted delay can be plotted versus SNR of two heterogeneous users.

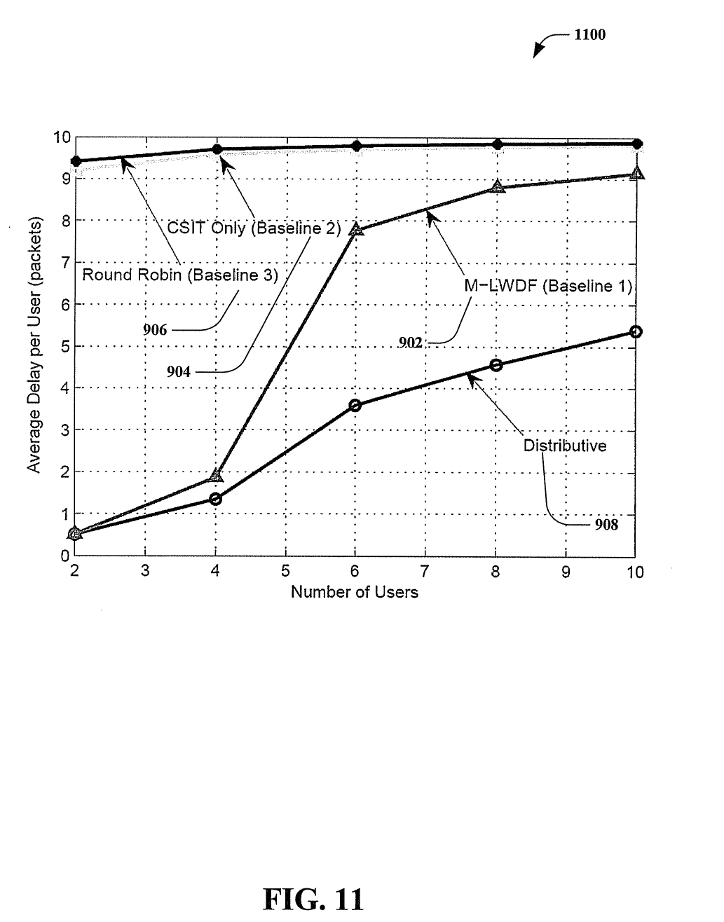

FIG. 11 depicts average delay per user versus the number of users, where the buffer size N_{Q}=10, the mean packet size N̅ₖ=78.125 Kbyte/pck, the average arrival rate λₖ=20 pck/s, and the queue weight βₖ=1 at a transmit SNR=10 dB. It is noted that the packet drop rate of the non-limiting implementation of a distributed solution 908 as described herein is 4% while the packet drop rate of the Baseline 1 902 (M-LWDF), Baseline 2 904 (CSIT Only), and Baseline 3 906 (Round Robin) are 4%, 8%, 9%, respectively. Thus, FIG. 11 illustrates the average delay per user of the distributed solution versus the number of users at a transmit SNR=10 dB, from which, it can be seen that the non-limiting implementation of a distributed solution 908 as described herein has significant gain in delay over the three baselines.

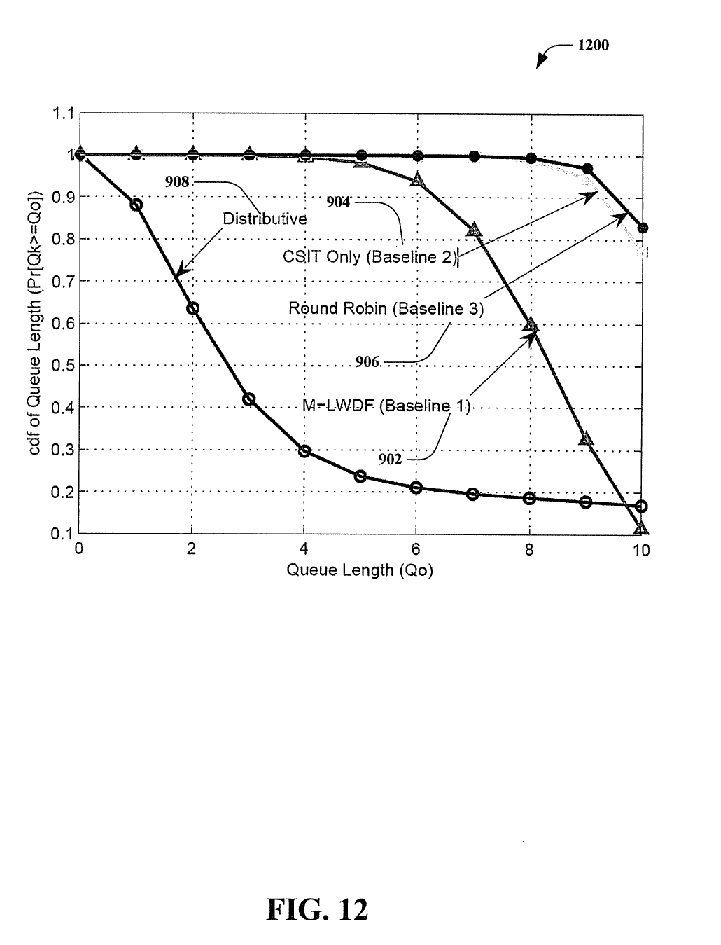

FIG. 12 depicts cumulative distribution function (cdf) of the queue length, where the buffer size N_{Q}=10, the mean packet size N̅ₖ=78.125 Kbyte/pck, the average arrival rate λₖ=20 pck/s, the queue weight βₖ=1, and the number of users K=6 at a transmit SNR=10 dB. The packet drop rate of the non-limiting implementation of a distributed solution 908 as described herein is 2%, while the packet drop rate of the Baseline 1 902 (M-LWDF), Baseline 2 904 (CSIT Only), and Baseline 3 906 (Round Robin) are 2%, 8%, 8% respectively. Accordingly, FIG. 12 further illustrates the cdf of the queue length for K=6 and SNR=10 dB, from which, it can be seen that the non-limiting implementation of a distributed solution 908 as described herein achieves a smaller queue length compared with the other baselines.

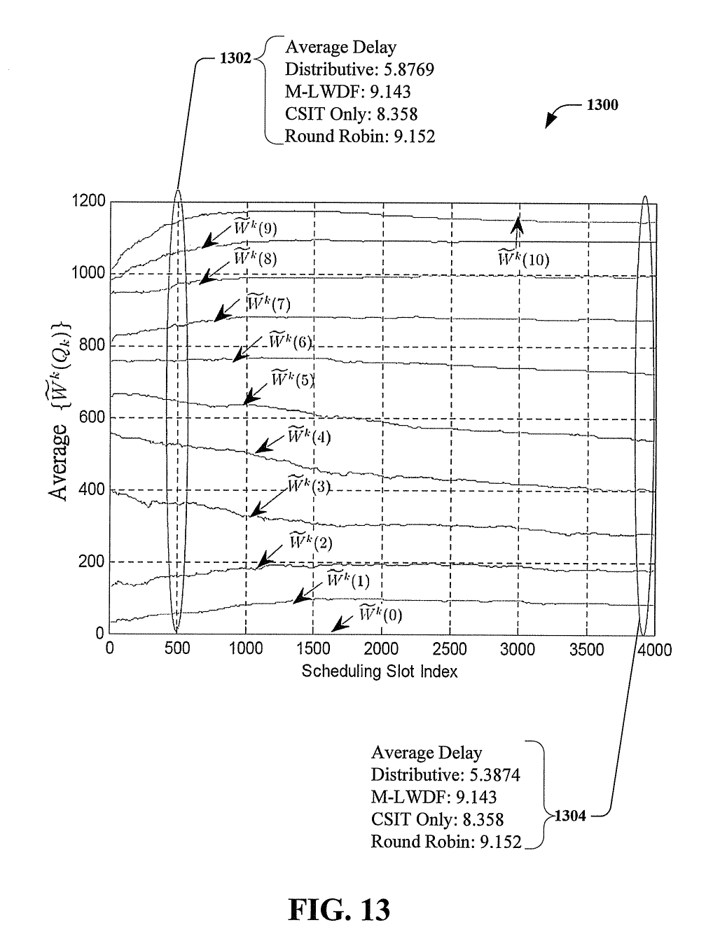

FIG. 13 illustrates convergence of the non-limiting implementation of a distributed solution 908 as described herein. For instance, in FIG. 13, the average {\tilde{W}^{k}(Qₖ)} of 10 users is depicted versus the scheduling slot index, where the number of users K=10, the buffer size N_{Q}=10, the mean packet size N̅ₖ=78.125 Kbyte/pck, the average arrival rate λₖ=20 pck/s, and the queue weight βₖ=1 at a transmit SNR=10 dB. The packet drop rate of the non-limiting implementation of a distributed solution 908 as described herein is 4%, while the packet drop rate of the Baseline 1 (M-LWDF), Baseline 2 (CSIT Only) and Baseline 3 (Round Robin) are 4%, 8%, 9%, respectively. Thus, FIG. 13 illustrates the convergence property of the various non-limiting implementations of distributed solution as described herein, from which, it can be seen that the distributed algorithm converges quite fast. The average delay corresponding to the average {\tilde{W}^{k}(Qₖ)} at the 500-th scheduling slot is 5.9 pck, which is much smaller than the other baselines. It can be noted that in conventional iterative algorithms for deterministic NUM, there is message passing between iterative steps within a CSI realization and these iterative steps (before convergence) involve substantial overhead because they do not carry useful payload. On the other hand, non-limiting implementations of distributed solution as described herein can be described as an online distributed algorithm and thus, slots before “convergence” can also carry useful payload (e.g., slots are not “wasted”).

It can be understood that while a brief overview of exemplary systems, methods, scenarios, and/or devices has been provided, the disclosed subject matter is not so limited. Thus, it can be further understood that various modifications, alterations, addition, and/or deletions can be made without departing from the scope of the embodiments as described herein. Accordingly, similar non-limiting implementations can be used or modifications and additions can be made to the described embodiments for performing the same or equivalent function of the corresponding embodiments without deviating therefrom.

Exemplary Computer Networks and Environments

One of ordinary skill in the art can appreciate that the disclosed subject matter can be implemented in connection with any computer or other client or server device, which can be deployed as part of a communications system, a computer network, or in a distributed computing environment, connected to any kind of data store. In this regard, the disclosed subject matter pertains to any computer system or environment having any number of memory or storage units, and any number of applications and processes occurring across any number of storage units or volumes, which may be used in connection with communication systems using the scheduling techniques, systems, and methods in accordance with the disclosed subject matter. The disclosed subject matter may apply to an environment with server computers and client computers deployed in a network environment or a distributed computing environment, having remote or local storage. The disclosed subject matter may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage, and disk storage for objects, such as files. Distributed computing takes advantage of network connectivity, allowing clients to leverage their collective power to benefit the entire enterprise. In this regard, a variety of devices may have applications, objects, or resources that may implicate the communication systems using the scheduling techniques, systems, and methods of the disclosed subject matter.

FIG. 14 provides a schematic diagram of an exemplary networked or distributed computing environment. The distributed computing environment comprises computing objects 1410a, 1410b, etc. and computing objects or devices 1420a, 1420b, 1420c, 1420d, 1420e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1440. This network may itself comprise other computing objects and computing devices that provide services to the system of FIG. 14, and may itself represent multiple interconnected networks. In accordance with an aspect of the disclosed subject matter, each object 1410a, 1410b, etc. or 1420a, 1420b, 1420c, 1420d, 1420e, etc. may contain an application that might make use of an API, or other object, software, firmware and/or hardware, suitable for use with the design framework in accordance with the disclosed subject matter.

It can also be appreciated that an object, such as 1420c, may be hosted on another computing device 1410a, 1410b, etc. or 1420a, 1420b, 1420c, 1420d, 1420e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There is a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for communicating information used in the communication systems using the scheduling techniques, systems, and methods according to the disclosed subject matter.

The Internet commonly refers to the collection of networks and gateways that utilize the Transmission Control Protocol/Internet Protocol (TCP/IP) suite of protocols, which are well known in the art of computer networking. The Internet can be described as a system of geographically distributed remote computer networks interconnected by computers executing networking protocols that allow users to interact and share information over network(s). Because of such widespread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, e.g., roughly a set of instructions or tasks, that requests a service provided by another program. The client process utilizes the requested service without having to “know” any working details about the other program or the service itself. In client/server architecture, particularly a networked system, a client is usually a computer that accesses shared network resources provided by another computer, e.g., a server. In the illustration of FIG. 14, as an example, computers 1420a, 1420b, 1420c, 1420d, 1420e, etc. can be thought of as clients and computers 1410a, 1410b, etc. can be thought of as servers where servers 1410a, 1410b, etc. maintain the data that is then replicated to client computers 1420a, 1420b, 1420c, 1420d, 1420e, etc., although any computer can be considered a client, a server, or both, depending on the circumstances. Any of these computing devices may be processing data or requesting services or tasks that may use or implicate the communication systems using the scheduling techniques, systems, and methods in accordance with the disclosed subject matter.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to communication (wired or wirelessly) using the scheduling techniques, systems, and methods of the disclosed subject matter may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 14 illustrates an exemplary networked or distributed environment, with server(s) in communication with client computer (s) via a network/bus, in which the disclosed subject matter may be employed. In more detail, a number of servers 1410a, 1410b, etc. are interconnected via a communications network/bus 1440, which may be a LAN, WAN, intranet, GSM network, the Internet, etc., with a number of client or remote computing devices 1420a, 1420b, 1420c, 1420d, 1420e, etc., such as a portable computer, handheld computer, thin client, networked appliance, or other device, such as a VCR, TV, oven, light, heater and the like in accordance with the disclosed subject matter. It is thus contemplated that the disclosed subject matter may apply to any computing device in connection with which it is desirable to communicate data over a network.

In a network environment in which the communications network/bus 1440 is the Internet, for example, the servers 1410a, 1410b, etc. can be Web servers with which the clients 1420a, 1420b, 1420c, 1420d, 1420e, etc. communicate via any of a number of known protocols such as HTTP. Servers 1410a, 1410b, etc. may also serve as clients 1420a, 1420b, 1420c, 1420d, 1420e, etc., as may be characteristic of a distributed computing environment.

As mentioned, communications to or from the systems incorporating the scheduling techniques, systems, and methods of the disclosed subject matter may ultimately pass through various media, either wired or wireless, or a combination, where appropriate. Client devices 1420a, 1420b, 1420c, 1420d, 1420e, etc. may or may not communicate via communications network/bus 14, and may have independent communications associated therewith. For example, in the case of a TV or VCR, there may or may not be a networked aspect to the control thereof. Each client computer 1420a, 1420b, 1420c, 1420d, 1420e, etc. and server computer 1410a, 1410b, etc. may be equipped with various application program modules or objects 1435a, 1435b, 1435c, etc. and with connections or access to various types of storage elements or objects, across which files or data streams may be stored or to which portion(s) of files or data streams may be downloaded, transmitted or migrated. Any one or more of computers 1410a, 1410b, 1420a, 1420b, 1420c, 1420d, 1420e, etc. may be responsible for the maintenance and updating of a database 1430 or other storage element, such as a database or memory 1430 for storing data processed or saved based on communications made according to the disclosed subject matter. Thus, the disclosed subject matter can be utilized in a computer network environment having client computers 1420a, 1420b, 1420c, 1420d, 1420e, etc. that can access and interact with a computer network/bus 1440 and server computers 1410a, 1410b, etc. that may interact with client computers 1420a, 1420b, 1420c, 1420d, 1420e, etc. and other like devices, and databases 1430.

### Exemplary Computing Device

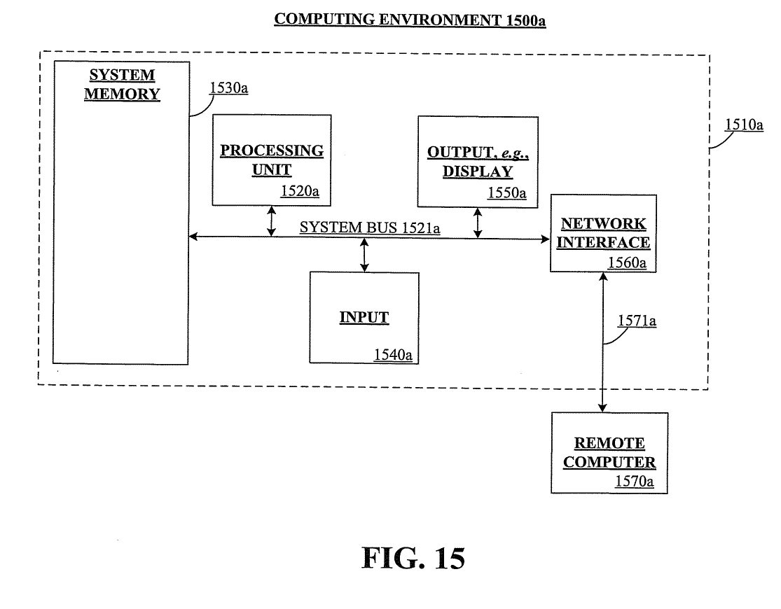

As mentioned, the disclosed subject matter applies to any device wherein it may be desirable to communicate data, e.g., to or from a mobile device. It should be understood, therefore, that handheld, portable and other computing devices and computing objects of all kinds are contemplated for use in connection with the disclosed subject matter, e.g., anywhere that a device may communicate data or otherwise receive, process or store data. Accordingly, the below general purpose remote computer described below in FIG. 15 is but one example, and the disclosed subject matter may be implemented with any client having network/bus interoperability and interaction. Thus, the disclosed subject matter may be implemented in an environment of networked hosted services in which very little or minimal client resources are implicated, e.g., a networked environment in which the client device serves merely as an interface to the network/bus, such as an object placed in an appliance.

Although not required, the some aspects of the disclosed subject matter can partly be implemented via an operating system, for use by a developer of services for a device or object, and/or included within application software that operates in connection with the component(s) of the disclosed subject matter. Software may be described in the general context of computer executable instructions, such as program modules, being executed by one or more computers, such as client workstations, servers or other devices. Those skilled in the art will appreciate that the disclosed subject matter may be practiced with other computer system configurations and protocols.

FIG. 15 thus illustrates an example of a suitable computing system environment 1500a in which some aspects of the disclosed subject matter may be implemented, although as made clear above, the computing system environment 1500a is only one example of a suitable computing environment for a media device and is not intended to suggest any limitation as to the scope of use or functionality of the disclosed subject matter. Neither should the computing environment 1500a be interpreted as having any dependency or requirement relating to any one or combination of components illustrated in the exemplary operating environment 1500a.

With reference to FIG. 15, an exemplary remote device for implementing the disclosed subject matter includes a general-purpose computing device in the form of a computer 1510a. Components of computer 1510a may include, but are not limited to, a processing unit 1520a, a system memory 1530a, and a system bus 1521a that couples various system components including the system memory to the processing unit 1520a. The system bus 1521a may be any of several types of bus structures including a memory bus or memory controller, a peripheral bus, and a local bus using any of a variety of bus architectures.

Computer 1510a typically includes a variety of computer readable media. Computer readable media can be any available media that can be accessed by computer 1510a. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510a. Communication media typically embodies computer readable instructions, data structures, program modules, or other data in a modulated data signal such as a carrier wave or other transport mechanism and includes any information delivery media.

The system memory 1530a may include computer storage media in the form of volatile and/or nonvolatile memory such as read only memory (ROM) and/or random access memory (RAM). A basic input/output system (BIOS), containing the basic routines that help to transfer information between elements within computer 1510a, such as during start-up, may be stored in memory 1530a. Memory 1530a typically also contains data and/or program modules that are immediately accessible to and/or presently being operated on by processing unit 1520a. By way of example, and not limitation, memory 1530a may also include an operating system, application programs, other program modules, and program data.

The computer 1510a may also include other removable/non-removable, volatile/nonvolatile computer storage media. For example, computer 1510a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus 1521a through a non-removable memory interface such as an interface, and a magnetic disk drive or optical disk drive is typically connected to the system bus 1521a by a removable memory interface, such as an interface.

A user may enter commands and information into the computer 1510a through input devices such as a keyboard and pointing device, commonly referred to as a mouse, trackball, or touch pad. Other input devices may include a microphone, joystick, game pad, satellite dish, scanner, wireless device keypad, voice commands, or the like. These and other input devices are often connected to the processing unit 1520a through user input 1540a and associated interface(s) that are coupled to the system bus 1521a, but may be connected by other interface and bus structures, such as a parallel port, game port or a universal serial bus (USB). A graphics subsystem may also be connected to the system bus 1521a. A monitor or other type of display device is also connected to the system bus 1521a via an interface, such as output interface 1550a, which may in turn communicate with video memory. In addition to a monitor, computers may also include other peripheral output devices such as speakers and a printer, which may be connected through output interface 1550a.

The computer 1510a may operate in a networked or distributed environment using logical connections to one or more other remote computers, such as remote computer 1570a, which may in turn have media capabilities different from device 1510a. The remote computer 1570a may be a personal computer, a server, a router, a network PC, a peer device, personal digital assistant (PDA), cell phone, handheld computing device, or other common network node, or any other remote media consumption or transmission device, and may include any or all of the elements described above relative to the computer 1510a. The logical connections depicted in FIG. 15 include a network 1571a, such local area network (LAN) or a wide area network (WAN), but may also include other networks/buses, either wired or wireless. Such networking environments are commonplace in homes, offices, enterprise-wide computer networks, intranets and the Internet.

When used in a LAN networking environment, the computer 1510a is connected to the LAN 1571a through a network interface or adapter. When used in a WAN networking environment, the computer 1510a typically includes a communications component, such as a modem, or other means for establishing communications over the WAN, such as the Internet. A communications component, such as a modem, which may be internal or external, may be connected to the system bus 1521a via the user input interface of input 1540a, or other appropriate mechanism. In a networked environment, program modules depicted relative to the computer 1510a, or portions thereof, may be stored in a remote memory storage device. It will be appreciated that the network connections shown and described are exemplary and other means of establishing a communications link between the computers may be used.

While the disclosed subject matter has been described in connection with the preferred embodiments of the various figures, it is to be understood that other similar embodiments may be used or modifications and additions may be made to the described embodiment for performing the same function of the disclosed subject matter without deviating therefrom. For example, one skilled in the art will recognize that the disclosed subject matter as described in the present application applies to communication systems using the disclosed scheduling techniques, systems, and methods and may be applied to any number of devices connected via a communications network and interacting across the network, either wired, wirelessly, or a combination thereof.

Accordingly, while words such as transmitted and received are used in reference to the described communications processes, it should be understood that such transmitting and receiving is not limited to digital communications systems, but could encompass any manner of sending and receiving data suitable for implementation of the described scheduling techniques. As a result, the disclosed subject matter should not be limited to any single embodiment, but rather should be construed in breadth and scope in accordance with the appended claims.

Exemplary Communications Networks and Environments

The above-described communication systems using the scheduling techniques, systems, and methods may be applied to any network, however, the following description sets forth some exemplary telephony radio networks and non-limiting operating environments for communications made incident to the communication systems using the scheduling techniques, systems, and methods of the disclosed subject matter. The below-described operating environments should be considered non-exhaustive, however, and thus, the below-described network architecture merely shows one network architecture into which the disclosed subject matter may be incorporated. One can appreciate, however, that the disclosed subject matter may be incorporated into any now existing or future alternative architecture for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the scheduling techniques, systems, and methods of the disclosed subject matter may be applied independently of the method of data transport, and does not depend on any particular network architecture, or underlying protocols.

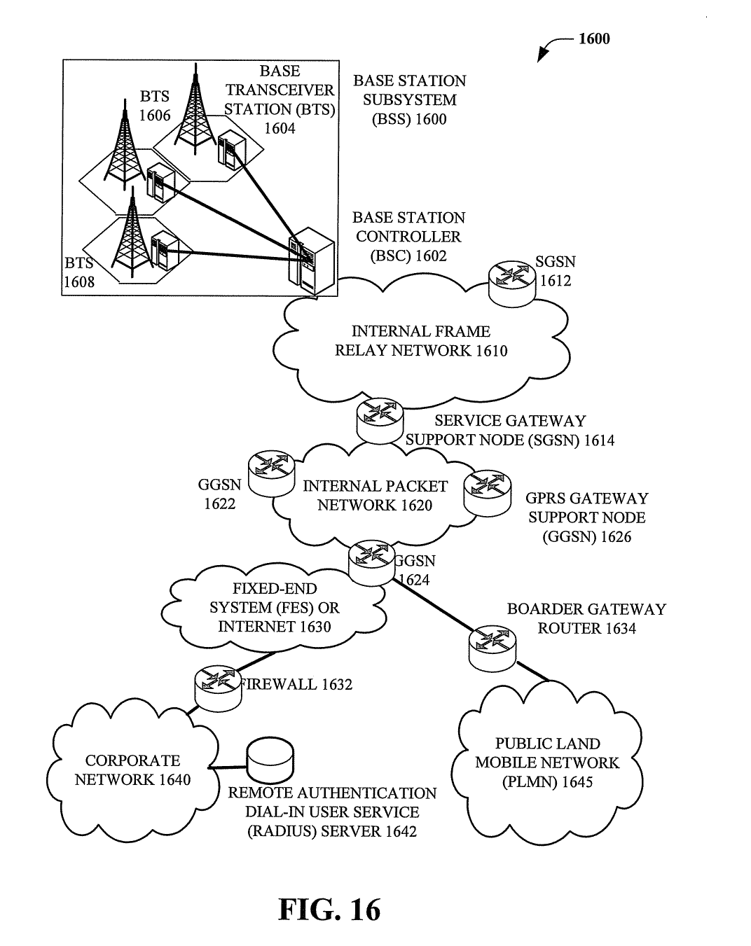

FIG. 16 depicts an overall block diagram of an exemplary packet-based mobile cellular network environment, such as a GPRS network, in which the disclosed subject matter may be practiced. In such an environment, there are one or more Base Station Subsystems (“BSS”) 1600 (only one is shown), each of which comprises a Base Station Controller (“BSC”) 1602 serving a plurality of Base Transceiver Stations (“BTS”) such as BTSs 1604, 1606, and 1608. BTSs 1604, 1606, 1608, etc. are the access points where users of packet-based mobile devices become connected to the wireless network. In exemplary fashion, the packet traffic originating from user devices is transported over the air interface to a BTS 1608, and from the BTS 1608 to the BSC 1602. Base station subsystems, such as BSS 1600, are a part of internal frame relay network 1610 that may include Service GPRS Support Nodes (“SGSN”) such as SGSN 1612 and 1614. Each SGSN is in turn connected to an internal packet network 1620 through which a SGSN 1612, 1614, etc. can route data packets to and from a plurality of gateway GPRS support nodes (GGSN) 1622, 1624, 1626, etc. As illustrated, SGSN 1614 and GGSNs 1622, 1624, and 1626 are part of internal packet network 1620. Gateway GPRS serving nodes 1622, 1624 and 1626 mainly provide an interface to external Internet Protocol (“IP”) networks such as Public Land Mobile Network (“PLMN”) 1645, corporate intranets 1640, or Fixed-End System (“FES”) or the public Internet 1630. As illustrated, subscriber corporate network 1640 may be connected to GGSN 1624 via firewall 1632; and PLMN 1645 is connected to GGSN 1624 via boarder gateway router 1634. The Remote Authentication Dial-In User Service (“RADIUS”) server 1642 may be used for caller authentication when a user of a mobile cellular device calls corporate network 1640.

Generally, there can be four different cell sizes in a GSM network-macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the disclosed subject matter described herein may have aspects that are wholly in hardware, partly in hardware and partly in software, as well as in software. Furthermore, aspects may be fully integrated into a single component, be assembled from discrete devices, or implemented as a combination suitable to the particular application and is a matter of design choice. As used herein, the terms “node,” “terminal,” “access point,” “base station,” “component,” “system,” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the systems of the disclosed subject matter, or certain aspects or portions thereof, may take the form of program code (e.g., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed subject matter. In the case of program code execution on programmable computers, the computing device generally includes a processor, a storage medium readable by the processor (including volatile and non-volatile memory and/or storage elements), at least one input device, and at least one output device. In addition, the components may communicate via local and/or remote processes such as in accordance with a signal having one or more data packets (e.g., data from one component interacting with another component in a local system, distributed system, and/or across a network such as the Internet with other systems via the signal).

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the some aspects of the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally, it is known that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the various embodiments.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

While for purposes of simplicity of explanation, methodologies disclosed herein are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the disclosed subject matter has been described in connection with the particular embodiments of the various figures, it is to be understood that other similar embodiments may be used or modifications and additions may be made to the described embodiment for performing the same function of the disclosed subject matter without deviating therefrom. Still further, the disclosed subject matter may be implemented in or across a plurality of processing chips or devices, and storage may similarly be effected across a plurality of devices. Therefore, the disclosed subject matter should not be limited to any single embodiment, but rather should be construed in breadth and scope in accordance with the appended claims.

What is claimed is:

1. A system for wireless communication resource allocation, comprising:
a base station (BS) configured to receive local channel state information (CSI) and local queue state information (QSI) from a plurality of mobile stations;
a resource allocation controller component associated with the BS configured to determine joint QSI as a function of the local QSI; and
a subband auction component associated with the resource allocation controller component and configured to perform a per-stage subband auction, based in part on the local CSI and the joint QSI.

2. The system of claim 1, wherein the subband auction component is further configured to determine a resource allocation policy that includes at least one of a power allocation policy or a subband allocation policy.

3. The system of claim 2, wherein the resource allocation controller component is further configured to determine whether at least one of an average power constraint or a packet drop constraint is satisfied for the resource allocation policy.

4. The system of claim 1, further comprising:
a subband allocation component associated with the resource allocation controller component and configured to assign a subband according to subband allocation results of the per-stage subband auction to at least one mobile station of the plurality of mobile stations, wherein the per-stage subband auction assigns subbands based on bids for resource allocation from the plurality of mobile stations.

5. The system of claim 4, wherein the subband allocation component is further configured to broadcast the subband allocation results to the plurality of mobile stations.

6. A method for resource allocation in a wireless communication system, the method comprising:
receiving bids for resource allocation from a plurality of mobile stations;
generating a resource allocation policy, based in part on the bids and a per-stage subband auction mechanism, for a current schedule slot of a plurality of schedule slots; and
assigning a subband, based in part on the resource allocation policy, to at least one mobile station of the plurality of mobile stations for the current slot.

7. The method of claim 6, wherein the generating the resource allocation policy includes determining the resource allocation policy based in part on observing joint channel state information and joint queue state information (QSI) associated with the plurality of mobile stations.

8. The method of claim 7, wherein the assigning the subband includes broadcasting subband allocation results of the per-stage subband auction mechanism to the plurality of mobile stations.

9. The method of claim 8, wherein the determining the resource allocation policy includes determining a subband allocation policy including the subband allocation results and a transmit power policy for the plurality of mobile stations.

10. The method of claim 9, further comprising:
receiving a transmission from the at least one mobile station employing a transmit power determined by the at the least one mobile station based in part on the subband allocation results.

11. The method of claim 7, further comprising:
approximating the joint QSI as a function of a set of local QSI associated with individual mobile stations of the plurality of mobile stations.

12. The method of claim 11, wherein the approximating the joint QSI as the function of the set of local QSI includes simultaneously updating Lagrange multipliers, based on an average power constraint and a packet drop constraint, and at least one of the set of local QSI associated with individual mobile stations.

13. The method of claim 12, further comprising:
determining whether the average power constraint and the packet drop constraint are satisfied for the resource allocation policy.

14. A resource allocation controller in a wireless communication system, the resource allocation controller comprising:
means for performing a per-stage subband auction, on behalf of a plurality of mobile users, for a current schedule slot of a plurality of schedule slots;
means for generating a resource allocation policy based in part on the per-stage subband auction; and
means for assigning a subband, based in part on the resource allocation policy, to at least one mobile user of the plurality of mobile users.

15. The resource allocation controller of claim 14, wherein the means for performing a per-stage subband auction includes means for receiving bids for resource allocation from the plurality of mobile users.

16. The resource allocation controller of claim 14, wherein the means for assigning a subband includes means for broadcasting subband allocation results of the per-stage subband auction to the plurality of mobile stations.

17. The resource allocation controller of claim 16, wherein the means for generating a resource allocation policy includes means for determining a subband allocation policy, including the subband allocation results, and a transmit power policy for the plurality of mobile users.

18. The resource allocation controller of claim 14, further comprising:
means for observing joint channel state information and joint queue state information (QSI) associated with the plurality of mobile users.

19. The resource allocation controller of claim 18, further comprising:
means for approximating the joint QSI as a function of a set of local QSI associated with individual mobile users of the plurality of mobile users.

20. The resource allocation controller of claim 19, further comprising:
means for determining whether at least one of an average power constraint or a packet drop constraint is satisfied for the resource allocation policy.

21. A computer readable storage medium comprising computer executable instructions that, in response to execution, cause a computing device to perform operations, comprising:
receiving bids for resource allocation from a plurality of mobile devices;
generating a resource allocation policy for a current schedule slot of a plurality of schedule slots including auctioning subbands based on the bids; and
assigning a subband, based in part on the resource allocation policy, to at least one mobile device of the plurality of mobile devices for the current slot.

22. A method that facilitates resource allocation in a wireless communication system, the method comprising:
providing, from a mobile device, channel state information and queue state information associated with the mobile device to a resource allocation controller;
transmitting a bid for resource allocation from the mobile device to the resource allocation controller;
receiving a subband allocation result from the resource allocation controller; and
determining a transmit power based on the subband allocation result.

23. A mobile device configured to provide channel state information (CSI) and queue state information (QSI) associated with the mobile device to a resource allocation controller, wherein the mobile device is further configured to transmit a bid for resource allocation to the resource allocation controller, wherein the mobile device is further configured to receive a subband assignment and a power allocation policy from the resource allocation controller, based on the CSI, the QSI, and the bid, and wherein the mobile device is further configured to determine a transmit power based on the subband assignment and the power allocation policy.
